(19) United States
(12) Patent Application Publication
(10) Pub. No.: US 2026/0321171 A1
(43) Pub. Date: Oct. 15, 2026

(54) PROJECTION DISPLAY APPARATUS

(71) Applicant: SONY SEMICONDUCTOR SOLUTIONS CORPORATION, KANAGAWA (JP)

(72) Inventors: SHOTA FUKUI, KANAGAWA (JP); SEIICHIRO JINTA, KANAGAWA (JP); TAIYOU KIMOTO, KANAGAWA (JP); SHINJI FUJIMOTO, KANAGAWA (JP)

(21) Appl. No.: 19/483,939

(22) PCT Filed: Apr. 1, 2024
(86) PCT No.: PCT/JP2024/013410

§ 371 Date: Nov. 12, 2025

(30) Foreign Application Priority Data
May 19, 2023 (JP) 2023-082838

(51) Int. Cl. G09G 3/00; G03B 21/00; G09G 3/36

(52) U.S. Cl. CPC G09G 3/007; G09G 3/002; G09G 3/3648; G03B 21/006; G09G 2300/0842; G09G 2310/08; G09G 2320/0257; G09G 2320/046; G09G 2340/0407

(57) ABSTRACT

A projection display apparatus according to one embodiment of the present disclosure includes: a display controller configured to generate, on the basis of a frame image, two or more sub-images out of multiple sub-images; a first optical system including a light source configured to emit light; a liquid crystal light valve configured to selectively perform first driving of driving multiple pixels by using a pixel voltage with a first polarity and second driving of driving the multiple pixels by using a pixel voltage with a second polarity, on the basis of each of the two or more sub-images, and modulate the light from the first optical system to thereby generate image light; a light shift device; and a second optical system. The liquid crystal light valve is configured to selectively perform the first driving or the second driving, on the basis of one of the two or more sub-images, in a predetermined driving cycle, and write multiple pixel voltages to the respective multiple pixels in a write period shorter than the driving cycle.

### TECHNICAL FIELD

The present disclosure relates to a projection display apparatus that displays an image.

### BACKGROUND ART

Display apparatuses include, for example, a projection display apparatus that displays an image by projecting image light generated by using a liquid crystal light valve onto a screen. Such projection display apparatuses include one that improves a display resolution to make the display resolution higher than a resolution of a liquid crystal light valve, by using a shift device configured to shift image light in an in-plane direction of an image (for example, PTL 1).

### CITATION LIST

### Patent Literature

PTL 1: Japanese Unexamined Patent Application Publication No. 2022-181331

### SUMMARY OF THE INVENTION

It is desired for a display apparatus to achieve high image quality, and a projection display apparatus is also expected to achieve high image quality.

It is desirable to provide a projection display apparatus that makes it possible to improve image quality.

A projection display apparatus according to one embodiment of the present disclosure includes a display controller, a first optical system, a liquid crystal light valve, a light shift device, and a second optical system. The display controller is configured to generate, on the basis of a frame image, two or more sub-images that are some or all of multiple sub-images each including multiple pixel values arranged in a predetermined arrangement pattern in the frame image. The first optical system includes a light source configured to emit light. The liquid crystal light valve includes multiple pixels, and is configured to selectively perform first driving of driving the multiple pixels by using a pixel voltage with a first polarity or second driving of driving the multiple pixels by using a pixel voltage with a second polarity, on the basis of each of the two or more sub-images, and modulate the light from the first optical system to thereby generate image light. The light shift device is configured to shift the image light in an in-plane direction of an image, depending on image light of which sub-image out of the multiple sub-images the image light is. The second optical system is configured to project the image light processed by the light shift device. The liquid crystal light valve is configured to selectively perform the first driving or the second driving, on the basis of one of the two or more sub-images, in a predetermined driving cycle, and write multiple pixel voltages to the respective multiple pixels in a write period shorter than the driving cycle.

In the projection display apparatus according to one embodiment of the present disclosure, the two or more sub-images that are some or all of the multiple sub-images are generated on the basis of the frame image. The multiple sub-pixels each include the multiple pixel values arranged in the predetermined arrangement pattern in the frame image. In the liquid crystal light valve, the first driving of driving the multiple pixels by using the pixel voltage with the first polarity and the second driving of driving the multiple pixels by using the pixel voltage with the second polarity are selectively performed, on the basis of each of the two or more sub-images. In the liquid crystal light valve, the light from the first optical system is modulated to thereby generate the image light. In the light shift device, the image light is shifted in the in-plane direction of the image, depending on image light of which sub-image out of the multiple sub-images the image light is. In the second optical system, the image light processed by the light shift device is projected. In the liquid crystal light valve, the first driving or the second driving is selectively performed, on the basis of one of the two or more sub-images, in the predetermined driving cycle. In the liquid crystal light valve, the multiple pixel voltages are written to the respective multiple pixels in the write period shorter than the driving cycle.

### BRIEF DESCRIPTION OF DRAWINGS

FIG. 1 is a configuration diagram illustrating a configuration example of a projection display apparatus according to a first embodiment of the present disclosure.

FIG. 2 is a block diagram illustrating a configuration example of a liquid crystal light valve illustrated in FIG. 1.

FIG. 3 is a circuit diagram illustrating a configuration example of a pixel illustrated in FIG. 2.

FIG. 4 is an explanatory diagram illustrating an operation example of the pixel illustrated in FIG. 3.

FIG. 5 is an explanatory diagram illustrating an operation example of an image processor illustrated in FIG. 1.

FIG. 6 is an explanatory diagram illustrating an operation example of a light shift device illustrated in FIG. 1.

FIG. 7 is another explanatory diagram illustrating the operation example of the light shift device illustrated in FIG. 1.

FIG. 8 is another explanatory diagram illustrating the operation example of the light shift device illustrated in FIG. 1.

FIG. 9 is another explanatory diagram illustrating an operation example of a display controller illustrated in FIG. 1.

FIG. 10 is a timing chart illustrating an operation example of the projection display apparatus illustrated in FIG. 1.

FIG. 11 is a timing chart illustrating an operation example of a projection display apparatus according to a reference example.

FIG. 12 is an explanatory diagram illustrating an operation example of the pixel according to a modification example.

FIG. 13 is a timing chart illustrating an operation example of the projection display apparatus according to a modification example of the first embodiment.

FIG. 14 is a timing chart illustrating an operation example of the projection display apparatus according to another modification example of the first embodiment.

FIG. 15 is a timing chart illustrating an operation example of the projection display apparatus according to another modification example of the first embodiment.

FIG. 16 is an explanatory diagram illustrating an example of a frame image and four sub-images.

FIG. 17A is an explanatory diagram illustrating another operation example of the pixel illustrated in FIG. 3.

FIG. 17B is an explanatory diagram illustrating another operation example of the pixel illustrated in FIG. 3.

FIG. 18 is a timing chart illustrating an operation example of the projection display apparatus according to another modification example of the first embodiment.

FIG. 19 is a timing chart illustrating an operation example of the projection display apparatus according to another modification example of the first embodiment.

FIG. 20 is an explanatory diagram illustrating an operation example of the display controller according to another modification example of the first embodiment.

FIG. 21 is a timing chart illustrating an operation example of the projection display apparatus according to another modification example of the first embodiment.

FIG. 22 is a configuration diagram illustrating a configuration example of a projection display apparatus according to another modification example of the first embodiment.

FIG. 23 is a configuration diagram illustrating a configuration example of a projection display apparatus according to a second embodiment.

FIG. 24 is an explanatory diagram illustrating an operation example of an image processor illustrated in FIG. 23.

FIG. 25 is a timing chart illustrating an operation example of the projection display apparatus illustrated in FIG. 23.

FIG. 26 is a timing chart illustrating an operation example of the projection display apparatus according to a modification example of the second embodiment.

FIG. 27 is a timing chart illustrating an operation example of the projection display apparatus according to another modification example of the second embodiment.

FIG. 28 is a perspective view of an example of an appearance configuration of a head-mounted display according to an application example.

FIG. 29 is a perspective view of an example of an appearance configuration of another head-mounted display according to the application example.

### MODES FOR CARRYING OUT THE INVENTION

In the following, description is given of embodiments of the present disclosure in detail with reference to the drawings. It is to be noted that the description is given in the following order.
1. First Embodiment
2. Second Embodiment
3. Application Examples

### 1. First Embodiment

### Configuration Example

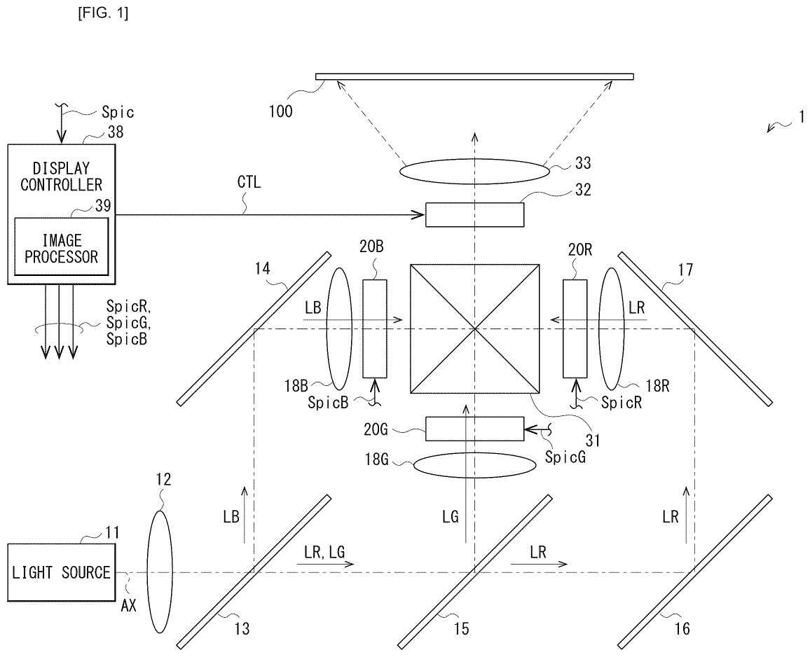

FIG. 1 illustrates a configuration example of a projection display apparatus (a projection display apparatus 1) according to a first embodiment. The projection display apparatus 1 is a display apparatus that projects an image onto a screen 100, and is a transmissive liquid crystal projector including a transmissive liquid crystal panel as a light valve. In this example, the projection display apparatus 1 is supplied with an image signal Spic including image data having a resolution of what is called 4K2K. The projection display apparatus 1 includes a light source 11, a condenser lens 12, a dichroic mirror 13, a total reflection mirror 14, a field lens 18B, a dichroic mirror 15, a field lens 18G, total reflection mirrors 16 and 17, a field lens 18R, three liquid crystal light valves 20R, 20G, and 20B, a cross prism 31, a light shift device 32, a projection lens 33, and a display controller 38.

The light source 11 is configured to emit white light along an optical path AX, and includes, for example, any of various lamps, a light-emitting diode, a laser light source, or the like. Examples of the various lamps include a halogen lamp, a metal halide lamp, and a xenon lamp. The condenser lens 12 is provided on the optical path AX, and is configured to collect light emitted from the light source 11. The dichroic mirror 13 is provided downstream of the condenser lens 12 on the optical path AX, and is configured to reflect blue light LB included in the white light emitted from the light source 11, and transmit red light LR and green light LG included in the white light. The total reflection mirror 14 is provided on an optical path of light reflected by the dichroic mirror 13, and is configured to reflect the blue light LB reflected by the dichroic mirror 13. The field lens 18B is provided on an optical path of light reflected by the total reflection mirror 14, and is configured to guide the blue light LB reflected by the total reflection mirror 14 to the liquid crystal light valve 20B. The dichroic mirror 15 is provided downstream of the dichroic mirror 13 on the optical path AX, and is configured to reflect the green light LG included in light transmitted through the dichroic mirror 13, and transmit the red light LR included in light transmitted through the dichroic mirror 13. The field lens 18G is configured to guide the green light LG reflected by the dichroic mirror 15 to the liquid crystal light valve 20G. The total reflection mirror 16 is provided downstream of the dichroic mirror 15 on the optical path AX, and is configured to reflect the red light LR transmitted through the dichroic mirror 15. The total reflection mirror 17 is provided on an optical path of light reflected by the total reflection mirror 16, and is configured to reflect the red light LR reflected by the total reflection mirror 16. The field lens 18R is provided on an optical path of light reflected by the total reflection mirror 17, and is configured to guide the red light LR reflected by the total reflection mirror 17 to the liquid crystal light valve 20R.

The three liquid crystal light valves 20R, 20G, and 20B each include a transmissive liquid crystal panel, and are configured to modulate respective pieces of incident light on the basis of image signals SpicR, SpicG, and SpicB, to thereby generate respective pieces of image light corresponding to the image signals. In this example, the liquid crystal light valves 20R, 20G, and 20B each have a resolution of what is called 2K1K. That is, the number of pixels in a horizontal direction is about 2000, and the number of pixels in a vertical direction is about 1000, for example. The liquid crystal light valve 20R is provided downstream of the field lens 18R on the optical path of light reflected by the total reflection mirror 17, and modulates the red light LR incident through the field lens 18R to thereby generate red image light, on the basis of the image signal SpicR indicating a red image. The liquid crystal light valve 20G is provided downstream of the field lens 18G on an optical path of light reflected by the dichroic mirror 15, and modulates the green light LG incident through the field lens 18G to thereby generate green image light, on the basis of the image signal SpicG indicating a green image. The liquid crystal light valve 20B is provided downstream of the field lens 18B on the optical path of light reflected by the total reflection mirror 14, and modulates the blue light LB incident from the field lens 18B to thereby generate blue image light, on the basis of the image signal SpicB indicating a blue image.

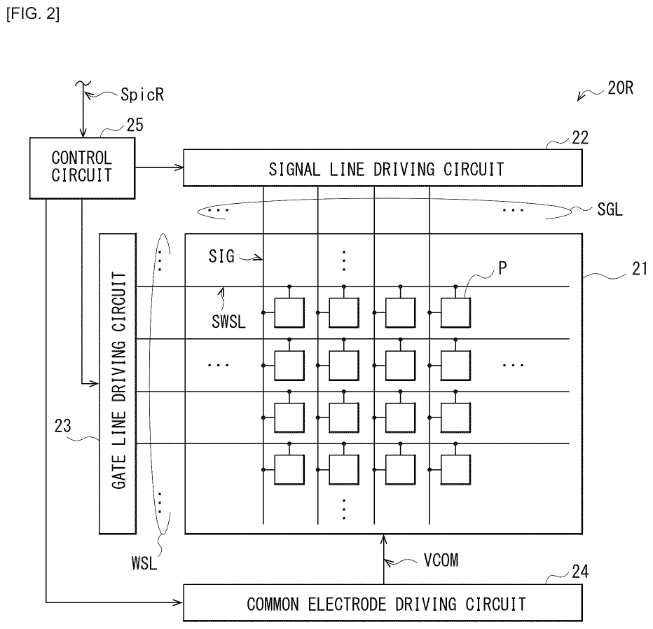

FIG. 2 illustrates a configuration example of the liquid crystal light valve 20R. Note that the same applies to the liquid crystal light valves 20G and 20B. The liquid crystal light valve 20R includes a pixel array 21, a signal line driving circuit 22, a gate line driving circuit 23, a common electrode driving circuit 24, and a control circuit 25.

The pixel array 21 includes multiple signal lines SGL, multiple gate lines WSL, and multiple pixels P arranged in a matrix.

The multiple signal lines SGL extend in the vertical direction, and are provided side by side in the horizontal direction. To each of the multiple signal lines SGL is applied a pixel signal SIG including a pixel voltage Vpix. The multiple gate lines WSL extend in the horizontal direction, and are provided side by side in the vertical direction. To each of the multiple gate lines WSL is applied a gate signal SWSL.

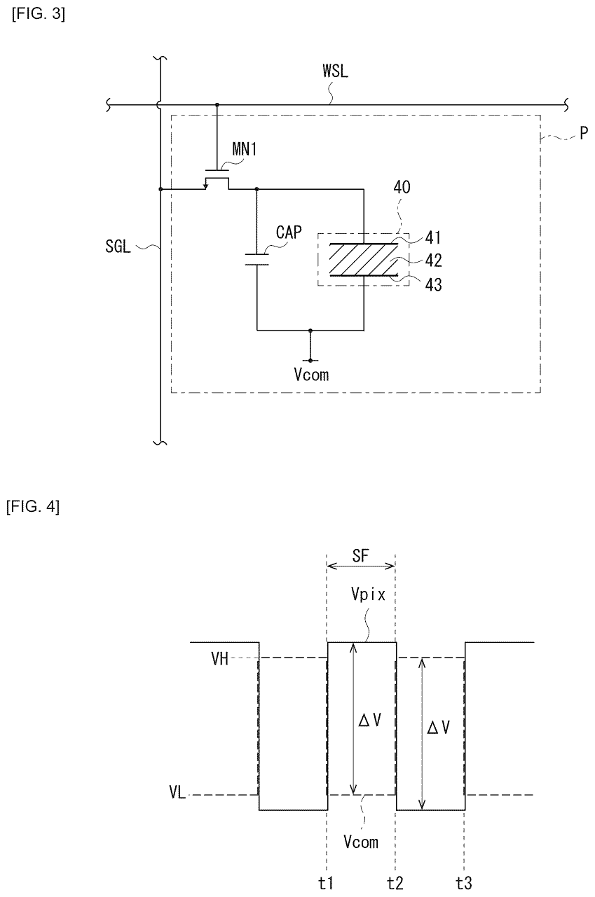

FIG. 3 illustrates a configuration example of the pixel P. The pixel P includes a transistor MN1, a liquid crystal display device 40, and a capacitor CAP.

The transistor MN1 is a thin-film transistor, and is an n-channel field-effect transistor (FET). The transistor MN1 has a gate coupled to the gate line WSL, a source coupled to the signal line SGL, and a drain coupled to the liquid crystal display device 40 and the capacitor CAP.

The liquid crystal display device 40 includes a pixel electrode 41, a liquid crystal layer 42, and a common electrode 43. The pixel electrode 41, the liquid crystal layer 42, and the common electrode 43 are disposed in this order. The pixel electrode 41 is provided individually for each of the multiple pixels P. The pixel electrode 41 is coupled to the drain of the transistor MN1 and one end of the capacitor CAP. The pixel voltage Vpix is applied to the pixel electrode 41 by the transistor MN1 being put into an on state. The common electrode 43 is provided in common to the multiple pixels P. To the common electrode 43 is applied a common voltage Vcom. The common voltage Vcom is an alternating-current voltage in this example. The liquid crystal layer 42 is configured to change light transmittance, on the basis of a voltage difference between a voltage of the pixel electrode 41 and a voltage of the common electrode 43.

The capacitor CAP has the one end coupled to the drain of the transistor MN1 and the pixel electrode 41 of the liquid crystal display device 40, and another end to which the common voltage Vcom is to be applied. The capacitor CAP holds the voltage difference between the pixel electrode 41 and the common electrode 43 in a case where the transistor MN1 is in an off state.

The signal line driving circuit 22 (FIG. 2) is configured to generate the pixel signal SIG including the pixel voltage Vpix on the basis of an instruction from the control circuit 25, and apply multiple pixel signals SIG to the respective multiple signal lines SGL in the pixel array 21, to thereby drive the pixel array 21.

The gate line driving circuit 23 is configured to generate the gate signal SWSL on the basis of an instruction from the control circuit 25, and apply multiple gate signals SWSL to the respective multiple gate lines WSL in the pixel array 21, to thereby drive the pixel array 21.

The common electrode driving circuit 24 is configured to drive the common electrode 43 (FIG. 3) in the pixel array 21, on the basis of an instruction from the control circuit 25. The common electrode driving circuit 24 applies the common voltage Vcom that is the alternating-current voltage to the common electrode 43 of the pixel array 21.

FIG. 4 illustrates an operation example of the pixel P. In this example, the common voltage Vcom transitions between a voltage VH and a voltage VL, each time a sub-frame period SF to be described later elapses. The voltage VH is a voltage higher than the voltage VL. For example, the common voltage Vcom is the voltage VL in a period from timing t1 to timing t2, and is the voltage VH in a period from timing t2 to timing t3.

The signal line driving circuit 22 writes, on the basis of a pixel value included in a frame image, for example, the pixel voltage Vpix with a positive polarity or the pixel voltage Vpix with a negative polarity corresponding to the pixel value to the pixel P. In this example, in the period from timing t1 to timing t2, the signal line driving circuit 22 applies the pixel voltage Vpix higher than the common voltage Vcom (the voltage VL) to the pixel electrode 41 of the pixel P. That is, the pixel voltage Vpix is a voltage with the positive polarity with respect to the common voltage Vcom (the voltage VL). In addition, in the period from timing t2 to timing t3, the signal line driving circuit 22 applies the pixel voltage Vpix lower than the common voltage Vcom (the voltage VH) to the pixel electrode 41 of the pixel P. That is, the pixel voltage Vpix is a voltage with the negative polarity with respect to the common voltage Vcom (the voltage VH). In this example, the pixel value of the pixel P from timing t1 to timing t2 and the pixel value of the pixel P from timing t2 to timing t3 are equal to each other. In this case, a voltage difference ΔV between the pixel voltage Vpix and the common voltage Vcom from timing t1 to timing t2, and the voltage difference ΔV between the pixel voltage Vpix and the common voltage Vcom from timing t2 to timing t3 are equal to each other. The light transmittance of the liquid crystal layer 42 is determined by the voltage difference ΔV (an absolute value) between the pixel voltage Vpix at the pixel electrode 41 and the common voltage Vcom at the common electrode 43. The light transmittance in the period from timing t1 to timing t2 is therefore the same as the light transmittance in the period from timing t2 to timing t3.

In this example, the signal line driving circuit 22 writes the pixel voltages Vpix with the polarities opposite to each other to the pixel P, in the period from timing t1 to timing t2 and the period from timing t2 to timing t3. Thus, for example, in a case where there is an impurity ion in the liquid crystal layer 42, the impurity ion does not greatly move in a period from timing t1 to timing t3. That is, for example, in a case where the impurity ion is a positive ion, the impurity ion moves toward the common electrode 43 in the period from timing t1 to timing t2 and moves toward the pixel electrode 41 in the period from timing t2 to timing t3, and there is therefore little substantial movement in the period from timing t1 to timing t3. For example, in a case where the impurity ion is a negative ion, the impurity ion moves toward the pixel electrode 41 in the period from timing t1 to timing t2 and moves toward the common electrode 43 in the period from timing t2 to timing t3, and there is therefore little substantial movement in the period from timing t1 to timing t3. As a result, it is possible to suppress burn-in in each of the multiple pixels P in the pixel array 21.

The control circuit 25 is configured to control an operation of the liquid crystal light valve 20R, on the basis of the image signal SpicR. The control circuit 25 performs predetermined processing on the basis of the image signal SpicR, to control operations of the signal line driving circuit 22, the gate line driving circuit 23, and the common electrode driving circuit 24. Thus, the control circuit 25 controls the operation of the liquid crystal light valve 20R to cause the liquid crystal light valve 20R to generate the image light corresponding to the image signal SpicR.

Although the liquid crystal light valve 20R has been described above as an example, the same applies to the liquid crystal light valves 20G and 20B.

The cross prism 31 (FIG. 1) is configured to combine the red image light generated by the liquid crystal light valve 20R, the green image light generated by the liquid crystal light valve 20G, and the blue image light generated by the liquid crystal light valve 20B to thereby generate combined image light, and emit the combined image light toward the light shift device 32. The cross prism 31 is provided at a position where the optical path of light reflected by the total reflection mirror 17, the optical path of light reflected by the dichroic mirror 15, and the optical path of light reflected by the total reflection mirror 14 intersect each other.

The light shift device 32 is provided on an optical path of the combined image light emitted from the cross prism 31, and is configured to shift the combined image light emitted from the cross prism 31 in an in-plane direction of an image, on the basis of a control signal CTL. The light shift device 32 includes, for example, a quartz plate. The light shift device 32 is configured to move the quartz plate, on the basis of the control signal CTL, to thereby shift the combined image light in the in-plane direction of the image. Note that, without being limited thereto, the light shift device 32 may shift the combined image light in the in-plane direction of the image by using, for example, a liquid crystal device.

The projection lens 33 is provided downstream of the light shift device 32 on the optical path of the combined image light emitted from the cross prism 31, and is configured to project the combined image light emitted from the cross prism 31 and shifted by the light shift device 32 onto the screen 100.

The display controller 38 is configured to control operations of the liquid crystal light valves 20R, 20G, and 20G and the light shift device 32, on the basis of the image signal Spic, to thereby control a display operation of the projection display apparatus 1. Specifically, the display controller 38 generates the image signals SpicR, SpicG, and SpicB and the control signal CTL, on the basis of the image signal Spic, supplies the image signals SpicR, SpicG, and SpicB respectively to the liquid crystal light valves 20R, 20G, and 20G, and supplies the control signal CTL to the light shift device 32, to thereby control the display operation of the projection display apparatus 1.

The display controller 38 includes an image processor 39. The image processor 39 is configured to generate image data of four sub-images related to red, on the basis of image data of a frame image related to red included in the image signal Spic, generate image data of four sub-images related to green, on the basis of image data of a frame image related to green included in the image signal Spic, and generate image data of four sub-images related to blue, on the basis of image data of a frame image related to blue included in the image signal Spic.

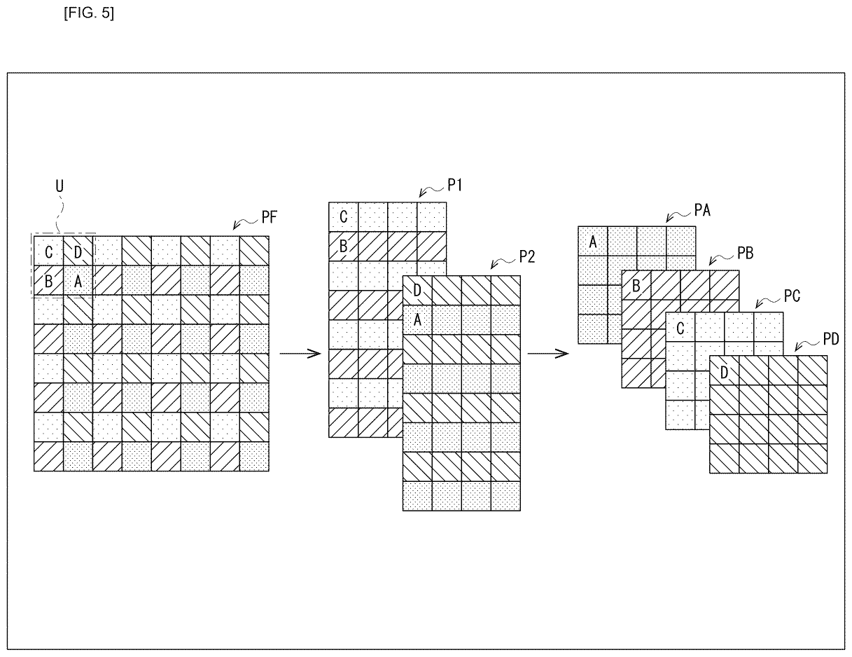

FIG. 5 illustrates an example of an operation of generating four sub-images PA, PB, PC, and PD on the basis of a frame image PF by the image processor 39. The frame image PF has a resolution of 4K2K, and the sub-images PA, PB, PC, and PD have a resolution of 2K1K. Note that, for convenience of description, FIG. 5 illustrates each of the frame image PF and the sub-images PA, PB, PC, and PD with a reduced number of pixels.

The frame image PF is divided in units (division units U) of four pixels A, B, C, and D arranged in two rows and two columns. The pixel A is a pixel disposed at the lower right of the division unit U, the pixel B is a pixel disposed at the lower left of the division unit U, the pixel C is a pixel disposed at the upper left of the division unit U, and the pixel D is a pixel disposed at the upper right of the division unit U. In the frame image PF, an arrangement pattern of multiple pixels A and an arrangement pattern of multiple pixels B are displaced from each other in the horizontal direction, and an arrangement pattern of multiple pixels C and an arrangement pattern of multiple pixels D are displaced from each other in the horizontal direction. In the frame image PF, the arrangement pattern of the multiple pixels A and the arrangement pattern of the multiple pixels D are displaced from each other in the vertical direction, and the arrangement pattern of the multiple pixels B and the arrangement pattern of the multiple pixels C are displaced from each other in the vertical direction.

In this example, the image processor 39 generates a sub-image P1 including pixel values of the multiple pixels B and pixel values of the multiple pixels C, on the basis of pixels of odd-numbered columns in the frame image PF, and generates a sub-image P2 including pixel values of the multiple pixels A and pixel values of the multiple pixels D, on the basis of pixels of even-numbered columns in the frame image PF. Further, the image processor 39 generates the sub-image PA including the pixel values of the multiple pixels A, on the basis of pixels of even-numbered rows in the sub-image P2, generates the sub-image PB including the pixel values of the multiple pixels B, on the basis of pixels of even-numbered rows in the sub-image P1, generates the sub-image PC including the pixel values of the multiple pixels C, on the basis of pixels of odd-numbered rows in the sub-image P1, and generates the sub-image PD including the pixel values of the multiple pixels D, on the basis of pixels of odd-numbered rows in the sub-image P2. The sub-images PA to PD each include multiple pixel values arranged in a predetermined arrangement pattern in the frame image PF. Specifically, the sub-image PA includes the multiple pixel values of the multiple pixels A disposed at the lower right of the respective division units U in the frame image PF, the sub-image PB includes the multiple pixel values of the multiple pixels B disposed at the lower left of the respective division units U in the frame image PF, the sub-image PC includes the multiple pixel values of the multiple pixels C disposed at the upper left of the respective division units U in the frame image PF, and the sub-image PD includes the multiple pixel values of the multiple pixels D disposed at the upper right of the respective division units U in the frame image PF.

In this manner, the image processor 39 generates the four sub-images PA, PB, PC, and PD related to red, on the basis of the frame image PF related to red, generates the four sub-images PA, PB, PC, and PD related to green, on the basis of the frame image PF related to green, and generates the four sub-images PA, PB, PC, and PD related to blue, on the basis of the frame image PF related to blue. Further, the display controller 38 supplies the image signal SpicR including image data of the four sub-images PA, PB, PC, and PD related to red generated by the image processor 39, to the liquid crystal light valve 20R, supplies the image signal SpicG including image data of the four sub-images PA, PB, PC, and PD related to green generated by the image processor 39, to the liquid crystal light valve 20G, and supplies the image signal SpicB including image data of the four sub-images PA, PB, PC, and PD related to blue generated by the image processor 39, to the liquid crystal light valve 20B.

The display controller 38 controls the operations of the liquid crystal light valves 20R, 20G, and 20B, to cause the liquid crystal light valves 20R, 20G, and 20B to respectively display the sub-image PA related to red, the sub-image PA related to green, and the sub-image PA related to blue in the same period. Thus, the cross prism 31 combines image light of the sub-image PA related to red, image light of the sub-image PA related to green, and image light of the sub-image PA related to blue, and emits combined image light for the sub-image PA toward the light shift device 32.

Similarly, the display controller 38 controls the operations of the liquid crystal light valves 20R, 20G, and 20B, to cause the liquid crystal light valves 20R, 20G, and 20B to respectively display the sub-image PB related to red, the sub-image PB related to green, and the sub-image PB related to blue in the same period. Thus, the cross prism 31 combines image light of the sub-image PB related to red, image light of the sub-image PB related to green, and image light of the sub-image PB related to blue, and emits combined image light for the sub-image PB toward the light shift device 32. The display controller 38 controls the operations of the liquid crystal light valves 20R, 20G, and 20B, to cause the liquid crystal light valves 20R, 20G, and 20B to respectively display the sub-image PC related to red, the sub-image PC related to green, and the sub-image PC related to blue in the same period. Thus, the cross prism 31 combines image light of the sub-image PC related to red, image light of the sub-image PC related to green, and image light of the sub-image PC related to blue, and emits combined image light for the sub-image PC toward the light shift device 32. The display controller 38 controls the operations of the liquid crystal light valves 20R, 20G, and 20B, to cause the liquid crystal light valves 20R, 20G, and 20B to respectively display the sub-image PD related to red, the sub-image PD related to green, and the sub-image PD related to blue in the same period. Thus, the cross prism 31 combines image light of the sub-image PD related to red, image light of the sub-image PD related to green, and image light of the sub-image PD related to blue, and emits combined image light for the sub-image PD toward the light shift device 32.

Further, the display controller 38 controls a shift operation on image light by the light shift device 32, in accordance with the combined image light incident on the light shift device 32.

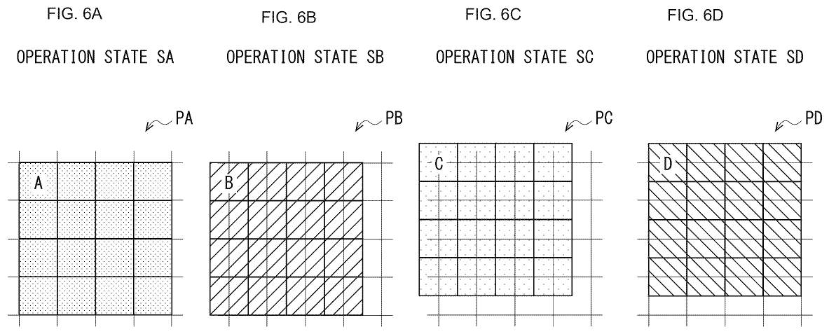

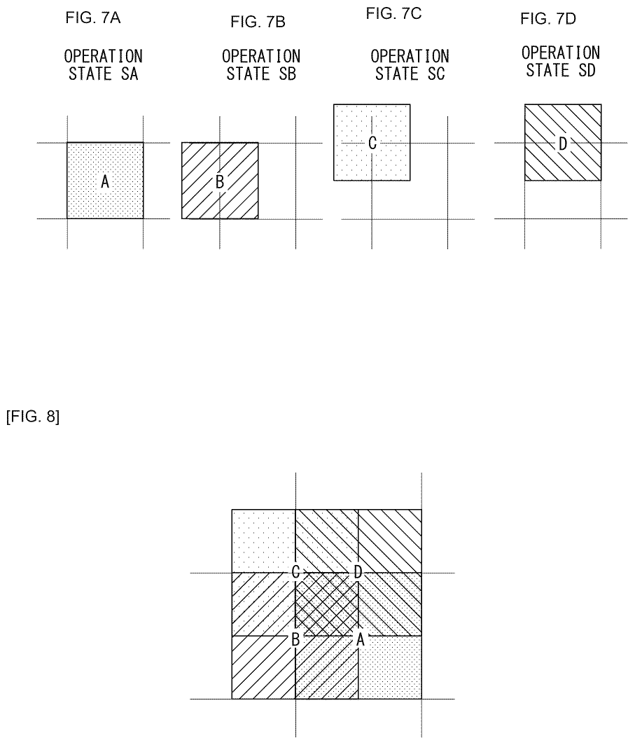

FIG. 6 illustrates an operation example of the light shift device 32, in which (A) illustrates an operation state SA upon incidence of the combined image light for the sub-image PA, (B) illustrates an operation state SB upon incidence of the combined image light for the sub-image PB, (C) illustrates an operation state SC upon incidence of the combined image light for the sub-image PC, and (D) illustrates an operation state SD upon incidence of the combined image light for the sub-image PD. Thin grid lines in FIG. 6 indicate a position of the combined image light in the operation state SA. FIG. 7 illustrates the shift operation by the light shift device 32, as with FIG. 6, and FIG. 7 illustrates the operation states SA to SD, focusing on one pixel.

In a period in which the combined image light for the sub-image PA is incident from the cross prism 31, the light shift device 32 puts the operation state into the operation state SA, as illustrated in (A) of FIG. 6 and (A) of FIG. 7. In the operation state SA, the light shift device 32 shifts the combined image light for the sub-image PA downward by 0.5 pixels, as compared with the operation state SD ((D) of FIG. 6 and (D) of FIG. 7).

In a period in which the combined image light for the sub-image PB is incident from the cross prism 31, the light shift device 32 puts the operation state into the operation state SB, as illustrated in (B) of FIG. 6 and (B) of FIG. 7. In the operation state SB, the light shift device 32 shifts the combined image light for the sub-image PB leftward by 0.5 pixels, as compared with the operation state SA ((A) of FIG. 6 and (A) of FIG. 7).

In a period in which the combined image light for the sub-image PC is incident from the cross prism 31, the light shift device 32 puts the operation state into the operation state SC, as illustrated in (C) of FIG. 6 and (C) of FIG. 7. In the operation state SC, the light shift device 32 shifts the combined image light for the sub-image PC upward by 0.5 pixels, as compared with the operation state SB ((B) of FIG. 6 and (B) of FIG. 7).

In a period in which the combined image light for the sub-image PD is incident from the cross prism 31, the light shift device 32 puts the operation state into the operation state SD, as illustrated in (D) of FIG. 6 and (D) of FIG. 7. In the operation state SD, the light shift device 32 shifts the combined image light for the sub-image PD rightward by 0.5 pixels, as compared with the operation state SC ((C) of FIG. 6 and (C) of FIG. 7).

FIG. 8 illustrates, in a superimposed manner, four pixels illustrated in FIG. 7. Because the light shift device 32 shifts the combined image light in accordance with the combined image light incident on the light shift device 32, as illustrated in FIG. 7, the pixels have center positions displaced from each other as illustrated in FIG. 8. As a result, the projection display apparatus 1 makes it possible to pseudo-display an image having the resolution of 4K2K, by using the liquid crystal light valves 20R, 20G, and 20B having the resolution of 2K1K.

Here, the display controller 38 corresponds to a specific example of a “display controller” in one embodiment of the present disclosure. For example, the light source 11, the condenser lens 12, the dichroic mirrors 13 and 15, the total reflection mirrors 16 and 17, and the field lens 18R corresponds to a specific example of a “first optical system” in one embodiment of the present disclosure. For example, the liquid crystal light valve 20R corresponds to a specific example of a “liquid crystal light valve” in one embodiment of the present disclosure. The light shift device 32 corresponds to a specific example of a “light shift device” in one embodiment of the present disclosure. The projection lens 33 corresponds to a specific example of a “second optical system” in one embodiment of the present disclosure. The frame image PF corresponds to a specific example of a “frame image” in one embodiment of the present disclosure. The sub-images PA, PB, PC, and PC correspond to a specific example of “multiple sub-images” in one embodiment of the present disclosure.

### Operation and Workings

Described next is an operation and workings of the projection display apparatus 1 of the present embodiment.

### Outline of Overall Operation

First, an outline of an overall operation of the projection display apparatus 1 will be described with reference to FIG. 1. The display controller 38 generates the image signals SpicR, SpicG, and SpicB and the control signal CTL, on the basis of the image signal Spic, supplies the image signals SpicR, SpicG, and SpicB respectively to the liquid crystal light valves 20R, 20G, and 20G, and supplies the control signal CTL to the light shift device 32, to thereby control the display operation of the projection display apparatus 1. The light source 11 emits white light. The condenser lens 12 collects light emitted from the light source 11. The dichroic mirror 13 reflects the blue light LB included in the white light emitted from the light source 11, and transmits the red light LR and the green light LG included in the white light. The total reflection mirror 14 reflects the blue light LB reflected by the dichroic mirror 13. The field lens 18B guides the blue light LB reflected by the total reflection mirror 14 to the liquid crystal light valve 20B. The liquid crystal light valve 20B modulates the blue light LB incident from the field lens 18B to thereby generate blue image light, on the basis of the image signal SpicB indicating a blue image.

The dichroic mirror 15 reflects the green light LG included in light transmitted through the dichroic mirror 13, and transmits the red light LR included in light transmitted through the dichroic mirror 13. The field lens 18G guides the green light LG reflected by the dichroic mirror 15 to the liquid crystal light valve 20G. The liquid crystal light valve 20G modulates the green light LG incident through the field lens 18G to thereby generate green image light, on the basis of the image signal SpicG indicating a green image.

The total reflection mirror 16 reflects the red light LR transmitted through the dichroic mirror 15. The total reflection mirror 17 reflects the red light LR reflected by the total reflection mirror 16. The field lens 18R guides the red light LR reflected by the total reflection mirror 17 to the liquid crystal light valve 20R. The liquid crystal light valve 20R modulates the red light LR incident through the field lens 18R to thereby generate red image light, on the basis of the image signal SpicR indicating a red image.

The cross prism 31 combines the red image light generated by the liquid crystal light valve 20R, the green image light generated by the liquid crystal light valve 20G, and the blue image light generated by the liquid crystal light valve 20B to thereby generate combined image light, and emits the combined image light toward the light shift device 32. The light shift device 32 shifts the combined image light emitted from the cross prism 31 in the in-plane direction of the image, on the basis of the control signal CTL. The projection lens 33 projects the combined image light emitted from the cross prism 31 and shifted by the light shift device 32 onto the screen 100.

### Detailed Operation

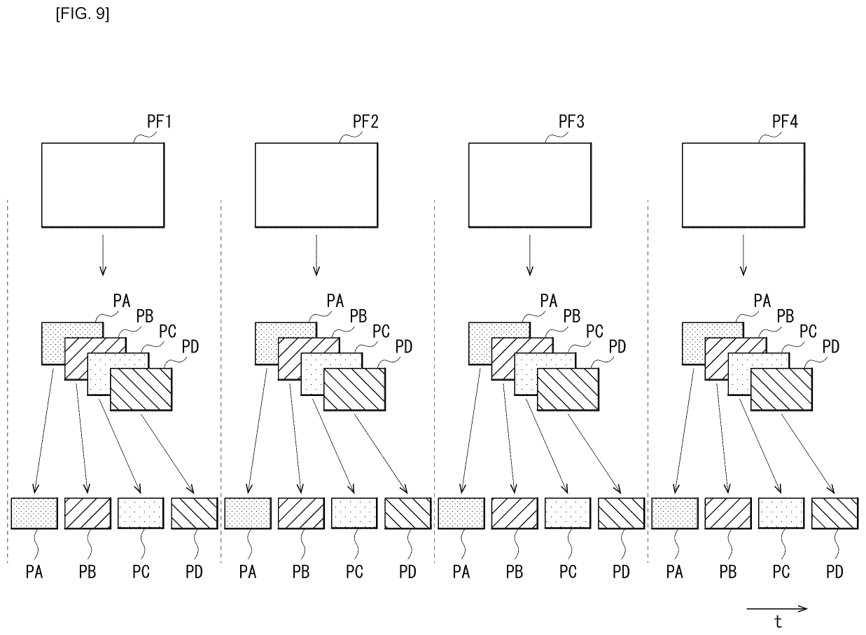

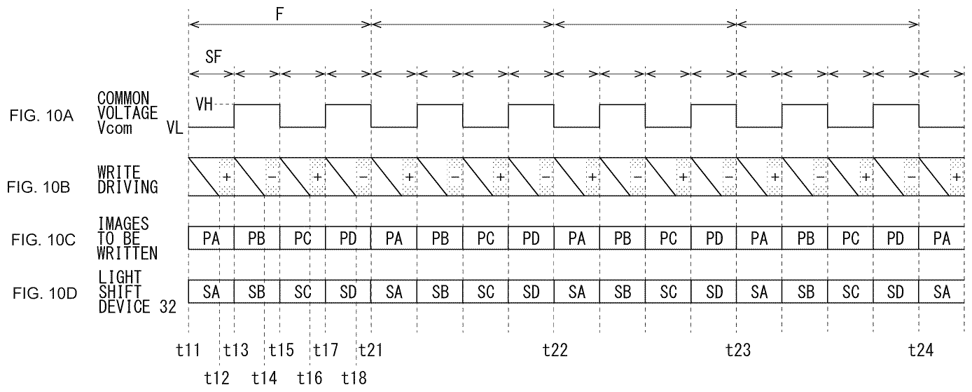

FIG. 9 illustrates an operation example of the image processor 39 in the projection display apparatus 1. FIG. 10 illustrates an operation example of the projection display apparatus 1, in which (A) illustrates a waveform of the common voltage Vcom in the liquid crystal light valves 20R, 20G, and 20B, (B) illustrates write driving in the liquid crystal light valves 20R, 20G, and 20B, (C) illustrates images to be written in the liquid crystal light valves 20R, 20G, and 20B, and (D) illustrates the operation state in the light shift device 32. In (B) of FIG. 10, “+” indicates writing the pixel voltage Vpix with the positive polarity to the pixel P, and “−” indicates writing the pixel voltage Vpix with the negative polarity to the pixel P. In this example, the light source 11 keeps emitting white light. In this example, the frame period F has a length of 16.7 [msec.] (= 1/60 [Hz]).

First, as illustrated in FIG. 9, the first frame image PF (a frame image PF1) is supplied to the projection display apparatus 1 by using the image signal Spic. The image processor 39 generates the four sub-images PA to PD on the basis of the frame image PF1, and the display controller 38 supplies the four sub-images PA to PD in this order to the liquid crystal light valves 20R, 20G, and 20B.

Specifically, the image processor 39 generates the four sub-images PA to PD related to red on the basis of the frame image PF1 related to red, generates the four sub-images PA to PD related to green on the basis of the frame image PF1 related to green, and generates the four sub-images PA to PD related to blue on the basis of the frame image PF1 related to blue. Further, the display controller 38 supplies the sub-images PA to PD related to red to the liquid crystal light valve 20R by using the image signal SpicR, supplies the sub-images PA to PD related to green to the liquid crystal light valve 20G by using the image signal SpicG, and supplies the sub-images PA to PD related to blue to the liquid crystal light valve 20B by using the image signal SpicB.

Further, as illustrated in FIG. 10, the projection display apparatus 1 displays the sub-image PA, the sub-image PB, the sub-image PC, and the sub-image PD in this order, in the frame period F from timing t11 to timing t21.

Specifically, in the sub-frame period SF from timing t11 to timing t13, for example, the liquid crystal light valve 20R sets the common voltage Vcom to the voltage VL ((A) of FIG. 10), and performs line-sequential scanning from the top to the bottom of the pixel array 21 to thereby perform write driving in a period from timing t11 to timing t12 ((B) of FIG. 10). In the write driving, the liquid crystal light valve 20R writes the pixel voltage Vpix with the positive polarity to each of the pixels P, on the basis of the sub-image PA related to red ((B) and (C) of FIG. 10). A time length from timing t11 to timing t12 is shorter than a time length of the sub-frame period SF and may be, for example, about ⅙ of a time length of the frame period F. In a period from timing t12 to timing t13, the voltage difference ΔV between the voltage of the pixel electrode 41 and the voltage of the common electrode 43 is set to a voltage difference based on the sub-image PA related to red, in all the pixels P from the top to the bottom of the pixel array 21, as indicated by hatching in (B) of FIG. 10. The same applies to the operations of the liquid crystal light valves 20G and 20B. In this manner, the liquid crystal light valves 20R, 20G, and 20B emit image light corresponding to the sub-image PA.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PA. In the period from timing t11 to timing t13, the light shift device 32 sets the operation state to the operation state SA, on the basis of the control signal CTL ((D) of FIG. 10). The projection display apparatus 1 projects the combined image light emitted from the cross prism 31 and shifted by the light shift device 32 onto the screen 100.

In addition, in the sub-frame period SF from timing t13 to timing t15, for example, the liquid crystal light valve 20R sets the common voltage Vcom to the voltage VH ((A) of FIG. 10), and performs line-sequential scanning from the top to the bottom of the pixel array 21 to thereby perform write driving in a period from timing t13 to timing t14 ((B) of FIG. 10). In the write driving, the liquid crystal light valve 20R writes the pixel voltage Vpix with the negative polarity to each of the pixels P, on the basis of the sub-image PB related to red ((B) and (C) of FIG. 10). A time length from timing t13 to timing t14 is shorter than the time length of the sub-frame period SF and may be, for example, about ⅙ of the time length of the frame period F. In a period from timing t14 to timing t15, the voltage difference ΔV between the voltage of the pixel electrode 41 and the voltage of the common electrode 43 is set to a voltage difference based on the sub-image PB related to red, in all the pixels P from the top to the bottom of the pixel array 21, as indicated by hatching in (B) of FIG. 10. The same applies to the operations of the liquid crystal light valves 20G and 20B. In this manner, the liquid crystal light valves 20R, 20G, and 20B emit image light corresponding to the sub-image PB.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PB. In the period from timing t13 to timing t15, the light shift device 32 sets the operation state to the operation state SB, on the basis of the control signal CTL ((D) of FIG. 10). The projection display apparatus 1 projects the combined image light emitted from the cross prism 31 and shifted by the light shift device 32 onto the screen 100.

In addition, in the sub-frame period SF from timing t15 to timing t17, for example, the liquid crystal light valve 20R sets the common voltage Vcom to the voltage VL ((A) of FIG. 10), and performs line-sequential scanning from the top to the bottom of the pixel array 21 to thereby perform write driving in a period from timing t15 to timing t16 ((B) of FIG. 10). In the write driving, the liquid crystal light valve 20R writes the pixel voltage Vpix with the positive polarity to each of the pixels P, on the basis of the sub-image PC related to red ((B) and (C) of FIG. 10). A time length from timing t15 to timing t16 is shorter than the time length of the sub-frame period SF and may be, for example, about ⅙ of the time length of the frame period F. In a period from timing t16 to timing t17, the voltage difference ΔV between the voltage of the pixel electrode 41 and the voltage of the common electrode 43 is set to a voltage difference based on the sub-image PC related to red, in all the pixels P from the top to the bottom of the pixel array 21, as indicated by hatching in (B) of FIG. 10. The same applies to the operations of the liquid crystal light valves 20G and 20B. In this manner, the liquid crystal light valves 20R, 20G, and 20B emit image light corresponding to the sub-image PC.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PC. In the period from timing t15 to timing t17, the light shift device 32 sets the operation state to the operation state SC, on the basis of the control signal CTL ((D) of FIG. 10). The projection display apparatus 1 projects the combined image light emitted from the cross prism 31 and shifted by the light shift device 32 onto the screen 100.

In addition, in the sub-frame period SF from timing t17 to timing t21, for example, the liquid crystal light valve 20R sets the common voltage Vcom to the voltage VH ((A) of FIG. 10), and performs line-sequential scanning from the top to the bottom of the pixel array 21 to thereby perform write driving in a period from timing t17 to timing t18 ((B) of FIG. 10). In the write driving, the liquid crystal light valve 20R writes the pixel voltage Vpix with the negative polarity to each of the pixels P, on the basis of the sub-image PD related to red ((B) and (C) of FIG. 10). A time length from timing t17 to timing t18 is, for example, shorter than the time length of the sub-frame period SF and may be about ⅙ of the time length of the frame period F. In a period from timing t18 to timing t21, the voltage difference ΔV between the voltage of the pixel electrode 41 and the voltage of the common electrode 43 is set to a voltage difference based on the sub-image PD related to red, in all the pixels P from the top to the bottom of the pixel array 21, as indicated by hatching in (B) of FIG. 10. The same applies to the operations of the liquid crystal light valves 20G and 20B. In this manner, the liquid crystal light valves 20R, 20G, and 20B emit image light corresponding to the sub-image PD.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PD. In the period from timing t17 to timing t21, the light shift device 32 sets the operation state to the operation state SD, on the basis of the control signal CTL ((D) of FIG. 10). The projection display apparatus 1 projects the combined image light emitted from the cross prism 31 and shifted by the light shift device 32 onto the screen 100.

In this manner, the projection display apparatus 1 displays the sub-image PA, the sub-image PB, the sub-image PC, and the sub-image PD in this order, in the frame period F from timing t11 to timing t21, as illustrated in FIG. 10.

Next, as illustrated in FIG. 9, the second frame image PF (a frame image PF2) is supplied to the projection display apparatus 1 by using the image signal Spic. The image processor 39 generates the four sub-images PA to PD on the basis of the frame image PF2, and the display controller 38 supplies the four sub-images PA to PD to the liquid crystal light valves 20R, 20G, and 20B. As illustrated in FIG. 10, in the frame period F from timing t21 to timing t22, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as with the operation in the frame period F from timing t11 to timing t21. The same applies to the liquid crystal light valves 20G and 20B. In this manner, the projection display apparatus 1 displays the sub-image PA, the sub-image PB, the sub-image PC, and the sub-image PD in this order.

Next, as illustrated in FIG. 9, the third frame image PF (a frame image PF3) is supplied to the projection display apparatus 1 by using the image signal Spic. The image processor 39 generates the four sub-images PA to PD on the basis of the frame image PF3, and the display controller 38 supplies the four sub-images PA to PD to the liquid crystal light valves 20R, 20G, and 20B. As illustrated in FIG. 10, in the frame period F from timing t22 to timing t23, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as with the operation in the frame period F from timing t11 to timing t21. The same applies to the liquid crystal light valves 20G and 20B. In this manner, the projection display apparatus 1 displays the sub-image PA, the sub-image PB, the sub-image PC, and the sub-image PD in this order.

Next, as illustrated in FIG. 9, the fourth frame image PF (a frame image PF4) is supplied to the projection display apparatus 1 by using the image signal Spic. The image processor 39 generates the four sub-images PA to PD on the basis of the frame image PF4, and the display controller 38 supplies the four sub-images PA to PD to the liquid crystal light valves 20R, 20G, and 20B. As illustrated in FIG. 10, in the frame period F from timing t23 to timing t24, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as with the operation in the frame period F from timing t11 to timing t21. The same applies to the liquid crystal light valves 20G and 20B. In this manner, the projection display apparatus 1 displays the sub-image PA, the sub-image PB, the sub-image PC, and the sub-image PD in this order.

As described above, in the projection display apparatus 1, the time length of the period of performing write driving by performing line-sequential scanning is made shorter than the time length of the sub-frame period SF. Thus, after write driving is ended until subsequent write driving is performed, the voltage difference ΔV between the voltage of the pixel electrode 41 and the voltage of the common electrode 43 is kept in all the pixels P from the top to the bottom of the pixel array 21. That is, in this period, the voltage difference based on one sub-image is set in all the pixels P from the top to the bottom of the pixel array 21. Accordingly, the projection display apparatus 1 makes it possible to improve image quality.

In addition, in the projection display apparatus 1, in this example, the pixel voltage Vpix with the positive polarity is written to each of the pixels P on the basis of the sub-image PA, the pixel voltage Vpix with the negative polarity is written to each of the pixels P on the basis of the sub-image PB, the pixel voltage Vpix with the positive polarity is written to each of the pixels P on the basis of the sub-image PC, and the pixel voltage Vpix with the negative polarity is written to each of the pixels P on the basis of the sub-image PD. Thus, for example, it is possible to suppress burn-in, as illustrated in FIG. 4, in the pixels P with the same pixel value in the sub-image PA and the sub-image PB. Similarly, for example, it is possible to suppress burn-in, as illustrated in FIG. 4, in the pixels P with the same pixel value in the sub-image PC and the sub-image PD. As a result, the projection display apparatus 1 makes it possible to improve the image quality.

### Reference Example

Next, the workings of the present embodiment will be described in comparison with a projection display apparatus according to a reference example. In the present reference example, the time length of the period of performing write driving by performing line-sequential scanning is made substantially the same as the time length of the sub-frame period SF.

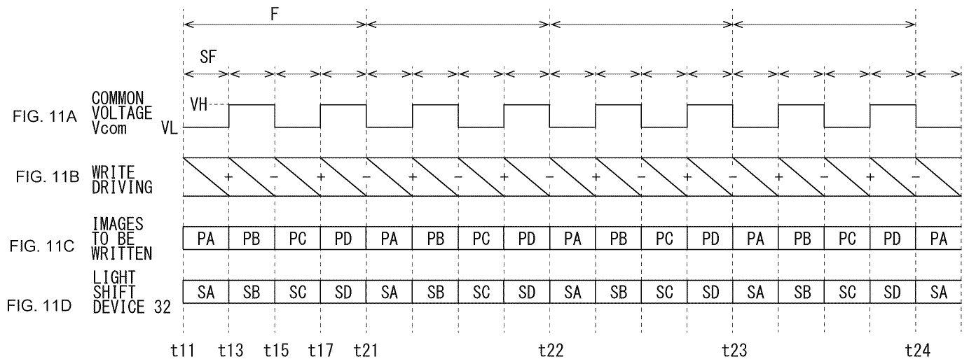

FIG. 11 illustrates an operation example of the projection display apparatus according to the reference example. In this example, in the sub-frame period SF from timing t11 to timing t13, for example, the liquid crystal light valve 20R sets the common voltage Vcom to the voltage VL ((A) of FIG. 11), and performs line-sequential scanning from the top to the bottom of the pixel array 21 to thereby perform write driving ((B) of FIG. 11). That is, in the projection display apparatus according to the reference example, write driving is performed by performing line-sequential scanning in the whole period of the sub-frame period SF, unlike the case of the present embodiment (FIG. 11). In addition, in the sub-frame period SF from timing t13 to timing t15, for example, the liquid crystal light valve 20R sets the common voltage Vcom to the voltage VH ((A) of FIG. 11), and performs line-sequential scanning from the top to the bottom of the pixel array 21 to thereby perform write driving ((B) of FIG. 11). In addition, in the sub-frame period SF from timing t15 to timing t16, for example, the liquid crystal light valve 20R sets the common voltage Vcom to the voltage VL ((A) of FIG. 11), and performs line-sequential scanning from the top to the bottom of the pixel array 21 to thereby perform write driving ((B) of FIG. 11). In addition, in the sub-frame period SF from timing t17 to timing t21, for example, the liquid crystal light valve 20R sets the common voltage Vcom to the voltage VH ((A) of FIG. 11), and performs line-sequential scanning from the top to the bottom of the pixel array 21 to thereby perform write driving ((B) of FIG. 11).

In the projection display apparatus according to the present reference example, the time of the period of performing write driving by performing line-sequential scanning is substantially the same as the time length of the sub-frame period SF, as described above. In this case, because there is almost no time after write driving is ended until subsequent write driving is performed, the pixel voltage Vpix related to a subsequent sub-image is written to the pixel P at the top of the pixel array 21 immediately after the pixel voltage Vpix related to a given sub-image is written to the pixel P at the bottom of the pixel array 21. Accordingly, in the projection display apparatus according to the present reference example, there is almost no period in which the voltage difference based on one sub-image is set in all the pixels P from the top to the bottom of the pixel array 21, unlike the case of the case of the present embodiment (FIG. 10), which causes the image quality to decrease. In the projection display apparatus according to the present reference example, because the image quality of the sub-images PA to PD thus decreases, the image quality when the sub-images PA to PD are displayed displaced from each other as illustrated in FIG. 6 to 8 also decreases, and it is not possible to sufficiently improve the resolution.

In contrast, in the projection display apparatus 1 according to the present embodiment, as illustrated in FIG. 10, the time length of the period of performing write driving by performing line-sequential scanning is made shorter than the time length of the sub-frame period SF. Thus, after write driving is ended until subsequent write driving is performed, the voltage difference ΔV between the voltage of the pixel electrode 41 and the voltage of the common electrode 43 is kept in all the pixels P from the top to the bottom of the pixel array 21. That is, in this period, the voltage difference based on one sub-image is set in all the pixels P from the top to the bottom of the pixel array 21. Thus, it is possible to improve the image quality of the sub-images PA to PD. This makes it possible to improve the image quality when the sub-images PA to PD are displayed displaced from each other as illustrated in FIG. 6 to 8, making it possible to improve the resolution.

As described above, the projection display apparatus 1 includes the display controller 38, the first optical system, the liquid crystal light valve (e.g., the liquid crystal light valve 20R), the light shift device 32, and the second optical system. The display controller 38 is configured to generate, on the basis of the frame image PF, the four sub-images PA to PD each including the multiple pixel values arranged in the predetermined arrangement pattern in the frame image PF. The first optical system includes the light source 11 configured to emit light. The liquid crystal light valve (e.g., the liquid crystal light valve 20R) includes the multiple pixels P, and is configured to selectively perform first driving of driving the multiple pixels P by using the pixel voltage Vpix with a first polarity or second driving of driving the multiple pixels P by using the pixel voltage Vpix with a second polarity, on the basis of each of the four sub-images PA to PD, and modulate the light from the first optical system to thereby generate image light. The light shift device 32 is configured to shift the image light in the in-plane direction of the image, depending on image light of which sub-image out of the four sub-images PA to PD the image light is. The second optical system is configured to project the image light processed by the light shift device 32. The liquid crystal light valve (e.g., the liquid crystal light valve 20R) is configured to selectively perform the first driving or the second driving, on the basis of one of the four sub-images PA to PD, in a predetermined driving cycle corresponding to the sub-frame period SF, and write the multiple pixel voltages Vpix to the respective multiple pixels P in a write period shorter than the driving cycle. Thus, the projection display apparatus 1 makes it possible to, for example, pseudo-display an image having the resolution of 4K2K, by using the liquid crystal light valves 20R, 20G, and 20B having the resolution of 2K1K, which makes it possible to improve the image quality. In addition, in the projection display apparatus 1, because write driving is performed in a period shorter than the sub-frame period SF, the voltage difference based on one sub-image is set in all the pixels P from the top to the bottom of the pixel array 21, after write driving is ended until subsequent write driving is performed. Accordingly, the projection display apparatus 1 makes it possible to improve the image quality.

In the projection display apparatus 1, the liquid crystal light valve (e.g., the liquid crystal light valve 20R) is configured to alternately repeat the first driving and the second driving in units of the sub-frame period SF. Thus, for example, it is possible to suppress burn-in, as illustrated in FIG. 4, in the pixels P with the same pixel value in the sub-image PA and the sub-image PB. Similarly, for example, it is possible to suppress burn-in, as illustrated in FIG. 4, in the pixels P with the same pixel value in the sub-image PC and the sub-image PD. Accordingly, the projection display apparatus 1 makes it possible to improve the image quality.

### Effects

As described above, in the present embodiment, the display controller, the first optical system, the liquid crystal light valve, the light shift device, and the second optical system are included. The display controller is configured to generate, on the basis of the frame image, the four sub-images each including the multiple pixel values arranged in the predetermined arrangement pattern in the frame image. The first optical system includes the light source configured to emit light. The liquid crystal light valve includes the multiple pixels, and is configured to selectively perform the first driving of driving the multiple pixels by using the pixel voltage with the first polarity or the second driving of driving the multiple pixels by using the pixel voltage with the second polarity, on the basis of each of the four sub-images, and modulate the light from the first optical system to thereby generate image light. The light shift device is configured to shift the image light in the in-plane direction of the image, depending on image light of which sub-image out of the four sub-images the image light is. The second optical system is configured to project the image light processed by the light shift device. The liquid crystal light valve is configured to selectively perform the first driving or the second driving, on the basis of one of the four sub-images, in the predetermined driving cycle corresponding to the sub-frame period, and write the multiple pixel voltages to the respective multiple pixels in the write period shorter than the driving cycle. This makes it possible to improve the image quality.

In the present embodiment, the liquid crystal light valve is configured to alternately repeat the first driving and the second driving in units of the sub-frame period, which makes it possible to improve the image quality.

### Modification Example 1-1

In the first embodiment described above, the common voltage Vcom that is the alternating-current voltage is applied to the common electrode 43, but this is non-limiting. Alternatively, for example, the common voltage Vcom that is a direct-current voltage may be applied to the common electrode 43. The present modification example is described in detail below.

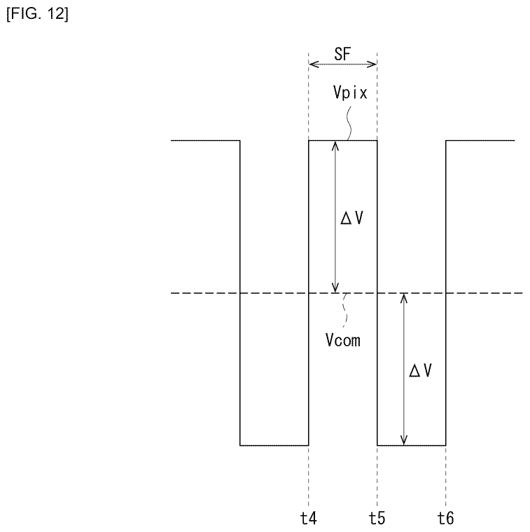

FIG. 12 illustrates an operation example of the pixel P according to the present modification example. The common electrode driving circuit 24 according to the present modification example applies the common voltage Vcom that is the direct-current voltage to the common electrode 43 of the pixel array 21.

The signal line driving circuit 22 according to the present modification example sequentially writes, on the basis of a pixel value included in a frame image, for example, the pixel voltage Vpix with the positive polarity and the pixel voltage Vpix with the negative polarity corresponding to the pixel value to the pixel P. Specifically, in a period from timing t4 to timing t5, the signal line driving circuit 22 applies the pixel voltage Vpix higher than the common voltage Vcom to the pixel electrode 41 of the pixel P. In addition, in a period from timing t5 to timing t6, the signal line driving circuit 22 applies the pixel voltage Vpix lower than the common voltage Vcom to the pixel electrode 41 of the pixel P. In this example, the pixel value of the pixel P from timing t4 to timing t5 and the pixel value of the pixel P from timing t5 to timing t6 are equal to each other. In this case, the voltage difference ΔV between the pixel voltage Vpix and the common voltage Vcom from timing t4 to timing t5, and the voltage difference ΔV between the pixel voltage Vpix and the common voltage Vcom from timing t5 to timing t6 are equal to each other. The light transmittance of the liquid crystal layer 42 is determined by the voltage difference ΔV (an absolute value) between the pixel voltage Vpix at the pixel electrode 41 and the common voltage Vcom at the common electrode 43. The light transmittance in the period from timing t4 to timing t5 is therefore the same as the light transmittance in the period from timing t5 to timing t6.

In this example, the signal line driving circuit 22 according to the present modification example writes the pixel voltages Vpix with the polarities opposite to each other to the pixel P, in the period from timing t4 to timing t5 and the period from timing t5 to timing t6. Thus, for example, in a case where there is an impurity ion in the liquid crystal layer 42, the impurity ion does not greatly move in a period from timing t4 to timing t6. As a result, it is possible to suppress burn-in in each of the multiple pixels P in the pixel array 21 according to the present modification example.

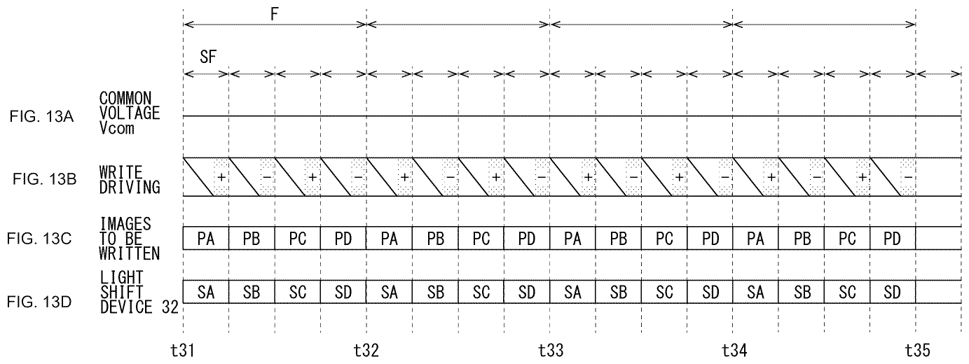

FIG. 13 illustrates an operation example of the projection display apparatus 1 according to the present modification example. In this example, the common voltage Vcom is the direct-current voltage, as illustrated in (A) of FIG. 13. In the frame period F from timing t31 to timing t32, the projection display apparatus 1 according to the present modification example displays the sub-image PA, the sub-image PB, the sub-image PC, and the sub-image PD in this order, as in the case of the first embodiment described above. The same applies to a period from timing t32 to timing t33, a period from timing t33 to timing t34, and a period from timing t34 to timing t35.

### Modification Example 1-2

In the first embodiment described above, for example, the sub-images PA to PD are displayed in the order of the sub-image PA, the sub-image PB, the sub-image PC, and the sub-image PD in the frame period F, but this is non-limiting, and a display order of the sub-images may be another order. Specifically, for example, the sub-images PA to PD may be displayed in the order of the sub-image PA, the sub-image PD, the sub-image PC, and the sub-image PB in the frame period F.

### Modification Example 1-3

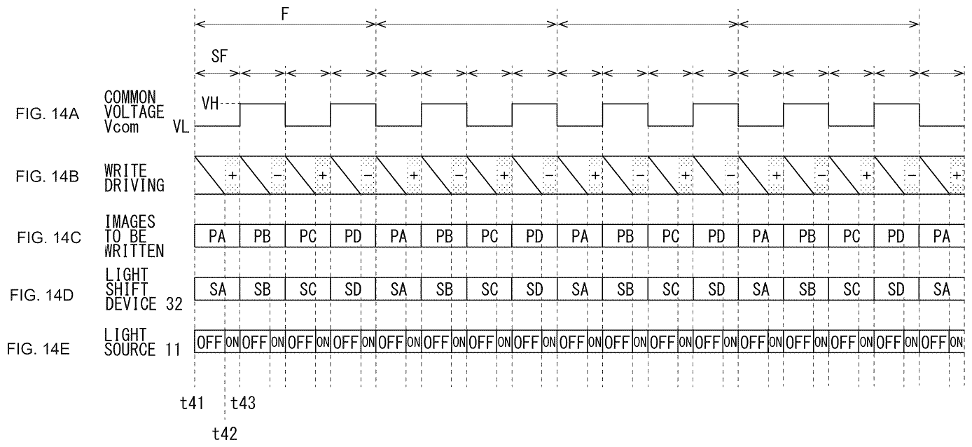

In the first embodiment described above, the light source 11 keeps emitting white light, but this is non-limiting. For example, in a case where the light source 11 includes a light-emitting diode, a laser light source, or the like, the light source 11 may emit light and stop emitting light in accordance with line-sequential scanning in the liquid crystal light valves 20R, 20G, and 20B, as illustrated in FIG. 14. (E) of FIG. 14 illustrates an operation of the light source 11. In (E) of FIG. 14, “ON” indicates that the light source 11 is emitting light, and “OFF” indicates that the light source 11 is emitting no light. In this example, of the sub-frame period SF from timing t41 to timing t43, the light source 11 emits no light in a period from timing t41 to timing t42, and the light source 11 emits light in a period from timing t42 to timing t43 ((E) of FIG. 14). That is, in the period from timing t41 to timing t42, the image is rewritten from the top to the bottom, and the light source 11 therefore emits no light in this period. Further, in the period from timing t42 to timing t43, the voltage difference ΔV between the voltage of the pixel electrode 41 and the voltage of the common electrode 43 is set to a voltage difference based on the sub-image PA, in all the pixels P from the top to the bottom of the pixel array 21, as indicated by hatching in (B) of FIG. 14, and the light source 11 therefore emits light in this period. Thus, in the projection display apparatus 1 according to the present modification example, the image in the period in which the image is rewritten from the top to the bottom is not viewed by an observer, which makes it possible to improve the image quality.

### Modification Example 1-4

In the first embodiment described above, the multiple pixels P are driven by the same driving method in each of the frame periods F, but this is non-limiting. Alternatively, for example, the driving method may be switched in units of the frame period F. The present modification example is described in detail below.

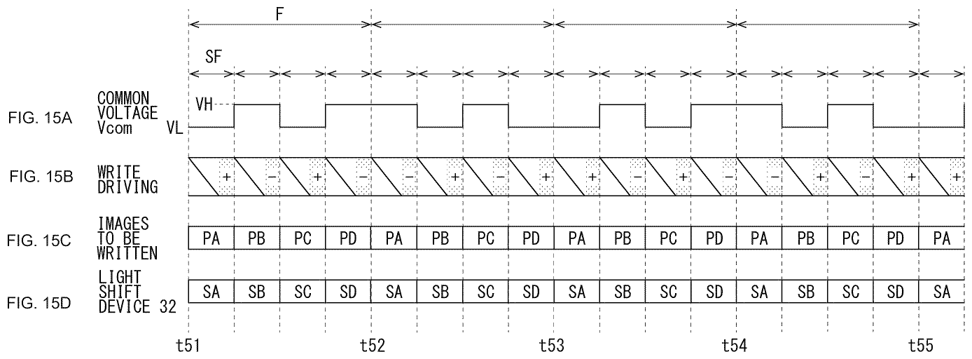

FIG. 15 illustrates an operation example of the projection display apparatus 1 according to the present modification example.

First, the first frame image PF (the frame image PF1) is supplied to the projection display apparatus 1 by using the image signal Spic, as in the case of the first embodiment described above (FIG. 9). The image processor 39 generates the four sub-images PA to PD on the basis of the frame image PF1, and the display controller 38 supplies the four sub-images PA to PD to the liquid crystal light valves 20R, 20G, and 20B. In the frame period F from timing t51 to timing t52, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as in the case of the first embodiment described above. The same applies to the liquid crystal light valves 20G and 20B. In this manner, the projection display apparatus 1 displays the sub-image PA, the sub-image PB, the sub-image PC, and the sub-image PD in this order.

Next, the second frame image PF (the frame image PF2) is supplied to the projection display apparatus 1 by using the image signal Spic, as in the case of the first embodiment described above (FIG. 9). The image processor 39 generates the four sub-images PA to PD on the basis of the frame image PF2, and the display controller 38 supplies the four sub-images PA to PD to the liquid crystal light valves 20R, 20G, and 20B. In the frame period F from timing t52 to timing t53, the liquid crystal light valve 20R sets the common voltage Vcom to the voltage VH and writes the pixel voltage Vpix with the negative polarity to each of the pixels P on the basis of the sub-image PA, sets the common voltage Vcom to the voltage VL and writes the pixel voltage Vpix with the positive polarity to each of the pixels P on the basis of the sub-image PB, sets the common voltage Vcom to the voltage VH and writes the pixel voltage Vpix with the negative polarity to each of the pixels P on the basis of the sub-image PC, and sets the common voltage Vcom to the voltage VL and writes the pixel voltage Vpix with the positive polarity to each of the pixels P on the basis of the sub-image PD. The same applies to the liquid crystal light valves 20G and 20B. In this manner, the projection display apparatus 1 displays the sub-image PA, the sub-image PB, the sub-image PC, and the sub-image PD in this order.

The operation in a period from timing t53 to timing t54 is similar to the operation in the period from timing t51 to timing t52. The operation in a period from timing t54 to timing t55 is similar to the operation in the period from timing t52 to timing t53.

As described above, in the projection display apparatus 1, the liquid crystal light valve (e.g., the liquid crystal light valve 20R) is configured to repeat the first driving and the second driving in this order, in units of the driving cycle (the sub-frame period SF), in a first frame period of performing display on the basis of the four sub-images PA to PD corresponding to a first frame image (e.g., the frame image PF1), and is configured to repeat the second driving and the first driving in this order, in units of the driving cycle (the sub-frame period SF), in a second frame period of performing display on the basis of the four sub-images corresponding to a second frame image (e.g., the frame image PF2) subsequent to the first frame image. Thus, for example, it is possible to suppress burn-in even in a case of displaying the frame image PF as a still image as described below.

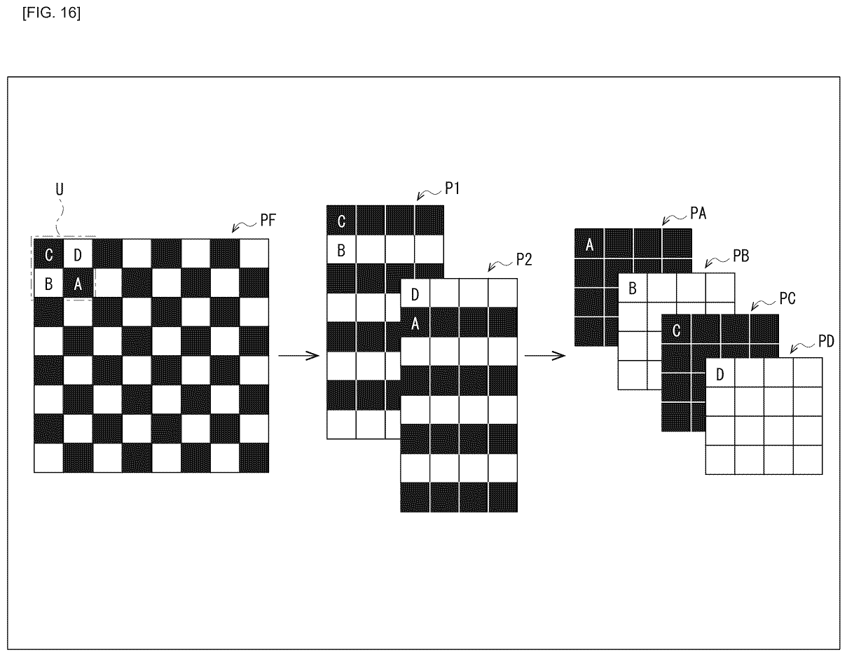

FIG. 16 illustrates an example of the frame image PF, and an example of the sub-images PA to PD generated on the basis of the frame image PF. The frame image PF is a checkerboard pattern in which the pixel P serves as a unit. The image processor 39 generates the sub-images PA to PD on the basis of such a frame image PF. For example, the image processor 39 generates, on the basis of the frame image PF, the sub-images PA and PC in which all the pixels P have a pixel value of zero, and the sub-images PB and PD in which all the pixels P have a maximum pixel value, as illustrated in FIG. 16.

For example, the liquid crystal light valve 20R drives the multiple pixels P, on the basis of such sub-images PA, PB, PC, and PD, as illustrated in FIG. 15.

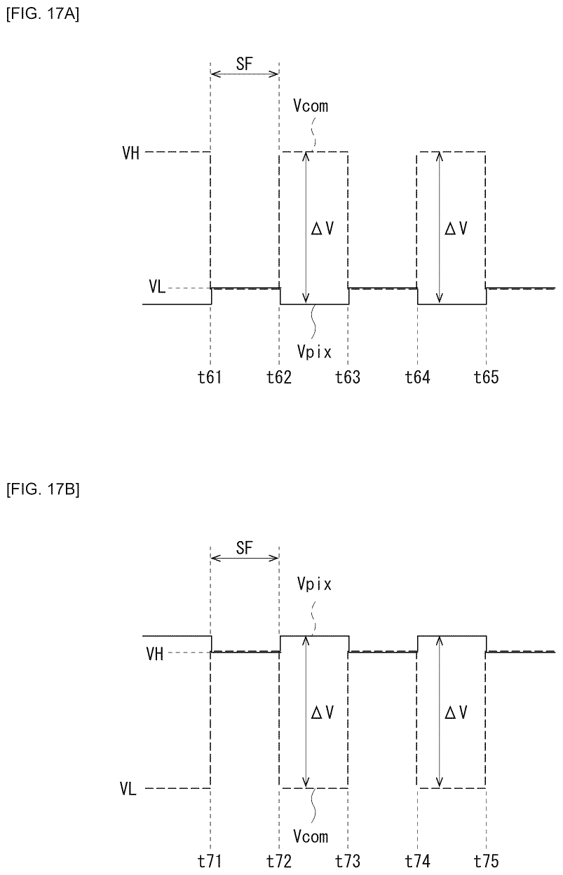

FIG. 17A illustrates an operation example of the pixel P in the period from timing t51 to timing t52, and FIG. 17B illustrates an operation example of the pixel P in the period from timing t52 to timing t53.

For example, in the period from timing t51 to timing t52 (FIG. 15), as illustrated in FIG. 17A, the liquid crystal light valve 20R sets the common voltage Vcom to the voltage VL and writes the pixel voltage Vpix with the positive polarity to each of the pixels P on the basis of the sub-image PA in a period from timing t61 to timing t62, sets the common voltage Vcom to the voltage VH and writes the pixel voltage Vpix with the negative polarity to each of the pixels P on the basis of the sub-image PB in a period from timing t62 to timing t63, sets the common voltage Vcom to the voltage VL and writes the pixel voltage Vpix with the positive polarity to each of the pixels P on the basis of the sub-image PC in a period from timing t63 to timing t64, and sets the common voltage Vcom to the voltage VH and writes the pixel voltage Vpix with the negative polarity to each of the pixels P on the basis of the sub-image PD in a period from timing t64 to timing t65. In this example, the pixel values in the sub-images PA and PC are zero, and the pixel values in the sub-images PB and PD are the maximum value, as illustrated in FIG. 15. Accordingly, as illustrated in FIG. 17A, the voltage difference ΔV is zero in the period from timing t61 to timing t62 of operating on the basis of the sub-image PA and the period from timing t63 to timing t64 of operating on the basis of the sub-image PC, and the voltage difference ΔV is large in the period from timing t62 to timing t63 of operating on the basis of the sub-image PB and the period from timing t64 to timing t65 of operating on the basis of the sub-image PD. In the period from timing t62 to timing t63 and the period from timing t64 to timing t65, the voltage of the pixel electrode 41 is lower than the voltage of the common electrode 43, because the liquid crystal light valve 20R writes the pixel voltage Vpix with the negative polarity.

For example, in the period from timing t52 to timing t53 (FIG. 15), as illustrated in FIG. 17B, the liquid crystal light valve 20R sets the common voltage Vcom to the voltage VH and writes the pixel voltage Vpix with the negative polarity to each of the pixels P on the basis of the sub-image PA in a period from timing t71 to timing t72, sets the common voltage Vcom to the voltage VL and writes the pixel voltage Vpix with the positive polarity to each of the pixels P on the basis of the sub-image PB in a period from timing t72 to timing t73, sets the common voltage Vcom to the voltage VH and writes the pixel voltage Vpix with the negative polarity to each of the pixels P on the basis of the sub-image PC in a period from timing t73 to timing t74, and sets the common voltage Vcom to the voltage VL and writes the pixel voltage Vpix with the positive polarity to each of the pixels P on the basis of the sub-image PD in a period from timing t74 to timing t75. In this example, the pixel values in the sub-images PA and PC are zero, and the pixel values in the sub-images PB and PD are the maximum value, as illustrated in FIG. 15. Accordingly, as illustrated in FIG. 17B, the voltage difference ΔV is zero in the period from timing t71 to timing t72 of operating on the basis of the sub-image PA and the period from timing t73 to timing t74 of operating on the basis of the sub-image PC, and the voltage difference ΔV is large in the period from timing t72 to timing t73 of operating on the basis of the sub-image PB and the period from timing t74 to timing t75 of operating on the basis of the sub-image PD. In the period from timing t72 to timing t73 and the period from timing t74 to timing t75, the voltage of the pixel electrode 41 is higher than the voltage of the common electrode 43, because the liquid crystal light valve 20R writes the pixel voltage Vpix with the positive polarity.

As described above, in the period from timing t51 to timing t52 and the period from timing t52 to timing t53, the pixel voltages Vpix that are written have the polarities opposite to each other. Accordingly, there is little substantial movement of an impurity ion in a period from timing t51 to timing t53. Thus, the projection display apparatus 1 according to the present modification example makes it possible to suppress burn-in.

### Modification Example 1-5

In the first embodiment described above, driving in the positive polarity and driving in the negative polarity are alternately repeated in units of the sub-frame period SF, but this is non-limiting. Alternatively, driving in the positive polarity and driving in the negative polarity may be alternately repeated in units of multiple sub-frame periods SF. The present modification example is described in detail below with reference to some examples.

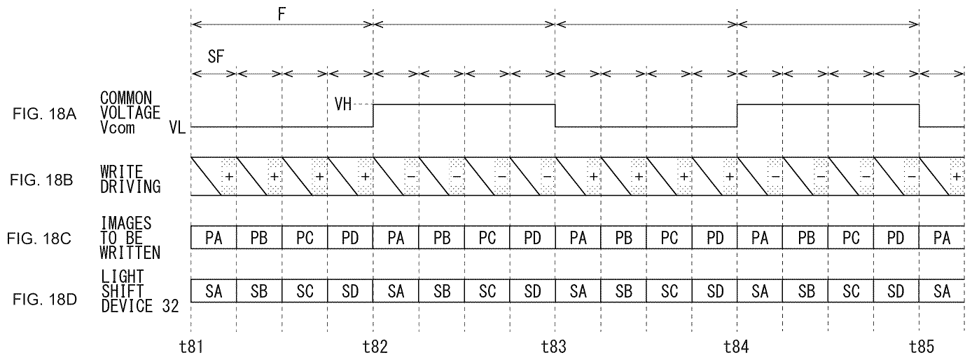

FIG. 18 illustrates an operation example of the projection display apparatus 1 according to the present modification example. In this example, the projection display apparatus 1 alternately repeats driving in the positive polarity and driving in the negative polarity in units of the frame period F. For example, in a period from timing t81 to timing t82, the liquid crystal light valve 20R keeps the common voltage Vcom at the voltage VL. Further, the liquid crystal light valve 20R writes the pixel voltage Vpix with the positive polarity to each of the pixels P on the basis of the sub-image PA, writes the pixel voltage Vpix with the positive polarity to each of the pixels P on the basis of the sub-image PB, writes the pixel voltage Vpix with the positive polarity to each of the pixels P on the basis of the sub-image PC, and writes the pixel voltage Vpix with the positive polarity to each of the pixels P on the basis of the sub-image PD. In addition, for example, in a period from timing t82 to timing t83, the liquid crystal light valve 20R keeps the common voltage Vcom at the voltage VH. Further, the liquid crystal light valve 20R writes the pixel voltage Vpix with the negative polarity to each of the pixels P on the basis of the sub-image PA, writes the pixel voltage Vpix with the negative polarity to each of the pixels P on the basis of the sub-image PB, writes the pixel voltage Vpix with the negative polarity to each of the pixels P on the basis of the sub-image PC, and writes the pixel voltage Vpix with the negative polarity to each of the pixels P on the basis of the sub-image PD. The operation in a period from timing t83 to timing t84 is the same as the operation in the period from timing t81 to timing t82, and the operation in a period from timing t84 to timing t85 is the same as the operation in the period from timing t82 to timing t83. Also in this case, it is possible to suppress burn-in as with the projection display apparatus 1 according to Modification Example 1-4.

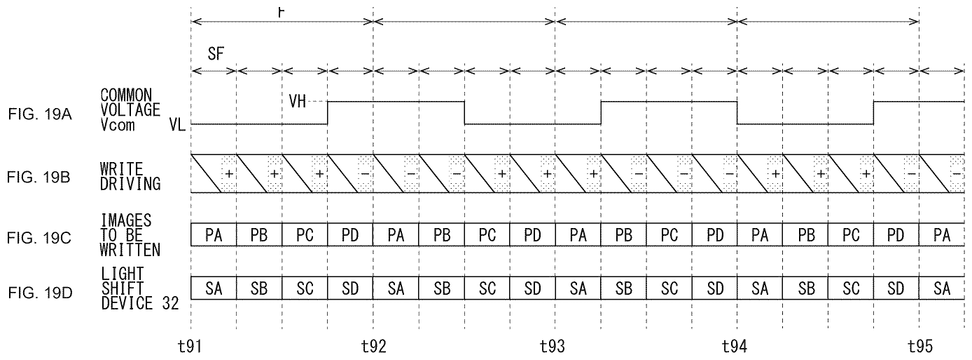

FIG. 19 illustrates an operation example of another projection display apparatus 1 according to the present modification example. In this example, the projection display apparatus 1 alternately repeats driving in the positive polarity and driving in the negative polarity in units of three sub-frame periods SF. In this example, for example, in a period from timing t91 to timing t92, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VL and writes the pixel voltage Vpix with the positive polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD. In addition, for example, in a period from timing t92 to timing t93, the liquid crystal light valve 20R sets the common voltage Vcom to the voltage VH and writes the pixel voltage Vpix with the negative polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VL and writes the pixel voltage Vpix with the positive polarity to each of the pixels P on the basis of the sub-image PD. In addition, for example, in a period from timing t93 to timing t94, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VH and writes the pixel voltage Vpix with the negative polarity to each of the pixels P on the basis of the sub-image PC, and sets the common voltage Vcom to the voltage VH and writes the pixel voltage Vpix with the negative polarity to each of the pixels P on the basis of the sub-image PD. The operation in a period from timing t94 to timing t95 is the same as the operation in the period from timing t91 to timing t92. Also in this case, it is possible to suppress burn-in as with the projection display apparatus 1 according to Modification Example 1-4. In addition, in the example of FIG. 19, the common voltage Vcom has a shorter cycle than in the example of FIG. 18. Thus, in the example of FIG. 19, it is possible to suppress image flickering (what is called flicker), as compared with the example of FIG. 18.

### Modification Example 1-6

In the first embodiment described above, the sub-image PA, the sub-image PB, the sub-image PC, and the sub-image PD are displayed in this order in each of the frame periods F, but this is non-limiting. Alternatively, for example, the display order of the sub-images PA to PD may be changed in units of the frame period F. The present modification example is described in detail below.

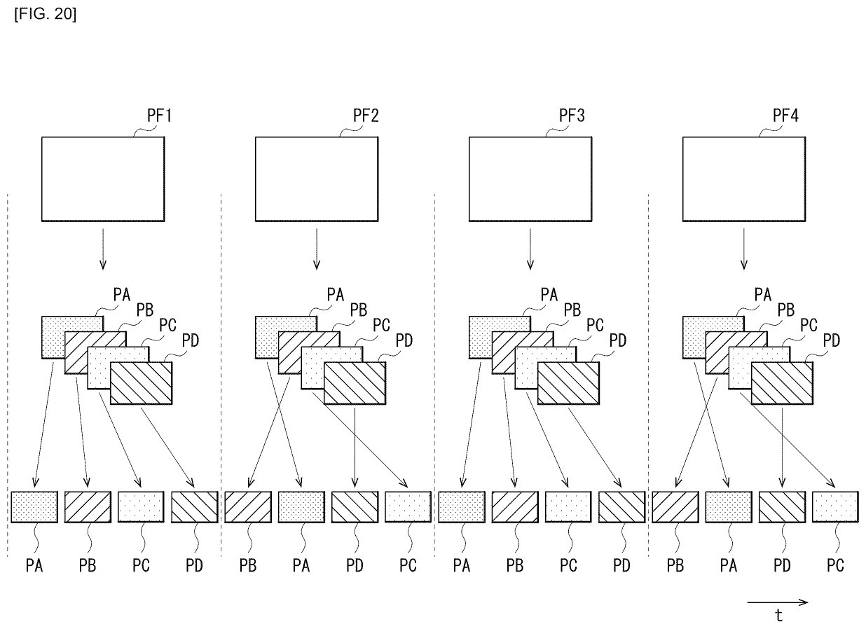

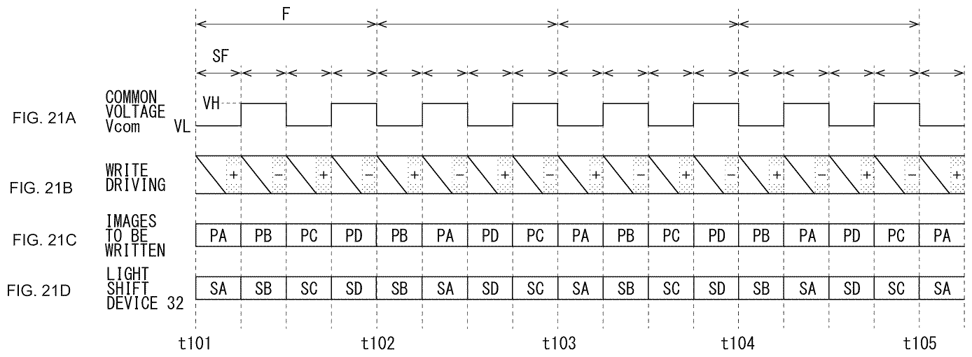

FIG. 20 illustrates an operation example of the image processor 39 in the projection display apparatus 1 according to the present modification example. FIG. 21 illustrates an operation example of the projection display apparatus 1 according to the present modification example.

First, as illustrated in FIG. 20, the first frame image PF (the frame image PF1) is supplied to the projection display apparatus 1 by using the image signal Spic. The image processor 39 generates the four sub-images PA to PD on the basis of the frame image PF1, and the display controller 38 supplies the four sub-images PA to PD in the order of the sub-image PA, the sub-image PB, the sub-image PC, and the sub-image PD to the liquid crystal light valves 20R, 20G, and 20B. As illustrated in FIG. 21, in the frame period F from timing t101 to timing t102, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD. The same applies to the liquid crystal light valves 20G and 20B. In this manner, the projection display apparatus 1 displays the sub-image PA, the sub-image PB, the sub-image PC, and the sub-image PD in this order.

Next, as illustrated in FIG. 20, the second frame image PF (the frame image PF2) is supplied to the projection display apparatus 1 by using the image signal Spic. The image processor 39 generates the four sub-images PA to PD on the basis of the frame image PF2, and the display controller 38 supplies the four sub-images PA to PD in the order of the sub-image PB, the sub-image PA, the sub-image PD, and the sub-image PC to the liquid crystal light valves 20R, 20G, and 20B. As illustrated in FIG. 21, in the frame period F from timing t102 to timing t103, the liquid crystal light valve 20R sets the common voltage Vcom to the voltage VL and writes the pixel voltage Vpix with the positive polarity to each of the pixels P on the basis of the sub-image PB, sets the common voltage Vcom to the voltage VH and writes the pixel voltage Vpix with the negative polarity to each of the pixels P on the basis of the sub-image PA, sets the common voltage Vcom to the voltage VL and writes the pixel voltage Vpix with the positive polarity to each of the pixels P on the basis of the sub-image PD, and sets the common voltage Vcom to the voltage VH and writes the pixel voltage Vpix with the negative polarity to each of the pixels P on the basis of the sub-image PC. The same applies to the liquid crystal light valves 20G and 20B. In this manner, the projection display apparatus 1 displays the sub-image PA, the sub-image PB, the sub-image PC, and the sub-image PD in this order.

The operation in a period from the timing t103 to t104 is similar to the operation in the period from the timing t101 to t102. The operation in a period from the timing t104 to t105 is similar to the operation in the period from the timing t102 to t103.

For example, in the first sub-frame period SF in the frame period F from timing t101 to timing t102, the liquid crystal light valve 20R sets the common voltage Vcom to the voltage VL and writes the pixel voltage Vpix with the positive polarity to each of the pixels P on the basis of the sub-image PA. In addition, in the second sub-frame period SF in the frame period F from timing t102 to timing t103, the liquid crystal light valve 20R sets the common voltage Vcom to the voltage VH and writes the pixel voltage Vpix with the negative polarity to each of the pixels P on the basis of the sub-image PA. This makes it possible to suppress burn-in as with the projection display apparatus 1 according to Modification Example 1-4.

In this example, the projection display apparatus 1 according to the present modification example alternately repeats the operation of displaying the sub-image PA, the sub-image PB, the sub-image PC, and the sub-image PD in order, and the operation of displaying the sub-image PB, the sub-image PA, the sub-image PD, the sub-image PC in order, but this is non-limiting. Alternatively, for example, one of these two operations may be selected in units of the frame period F, to make burn-in less likely to be displayed. The present modification example is described in detail below.

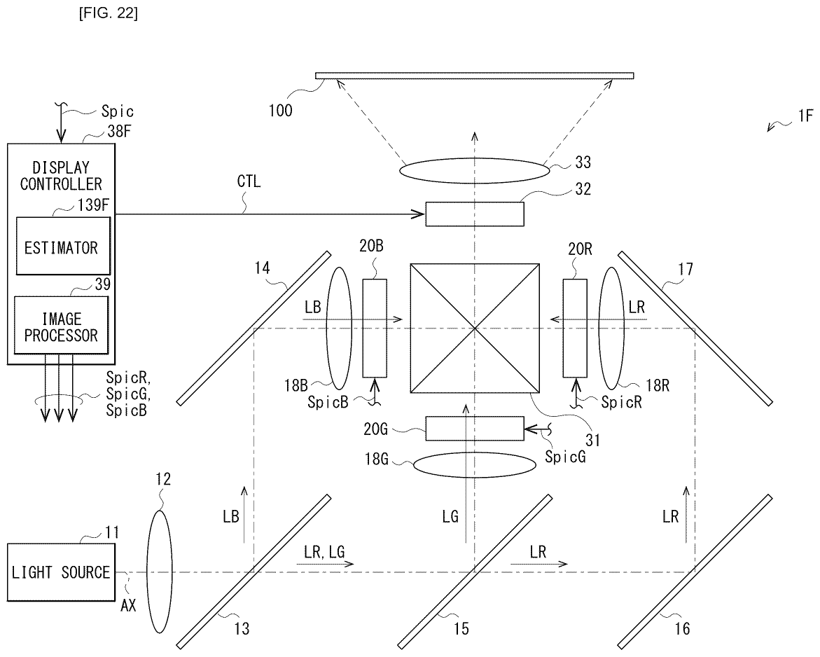

FIG. 22 illustrates a configuration example of a projection display apparatus 1F according to the present modification example. The projection display apparatus 1F includes a display controller 38F. The display controller 38F includes an estimator 139F. The estimator 139 is configured to estimate a burn-in level in each of the liquid crystal light valves 20R, 20G, and 20B. The display controller 38F selects, on the basis of a result of the estimation by the estimator 139, for example, one of a first operation of displaying the sub-image PA, the sub-image PB, the sub-image PC, and the sub-image PD in order, and a second operation of displaying the sub-image PB, the sub-image PA, the sub-image PD, and the sub-image PC in order.

For example, the estimator 139F estimates the burn-in level in each of all the pixels P of the liquid crystal light valve 20R, on the basis of each of the sub-images PA to PD related to red generated on the basis of the first frame image PF1. A value of the burn-in level may be, for example, a value obtained by subtracting the common voltage Vcom from the pixel voltage Vpix. For example, the value of the burn-in level is a positive value in a case where driving in the positive polarity is performed, and is a negative value in a case where driving in the negative polarity is performed. The estimator 139F obtains the sum of the values of four burn-in levels in four sub-frame periods SF, to thereby calculate a substantial burn-in level, for each of all the pixels P. Further, the estimator 139F calculates an average value of the respective substantial burn-in levels in all the pixels P, as an average burn-in level related to the frame image PF1 in the liquid crystal light valve 20R. Similarly, the estimator 139F calculates the average burn-in level related to the frame image PF1 in the liquid crystal light valve 20G, and the average burn-in level related to the frame image PF1 in the liquid crystal light valve 20B.

In addition, the estimator 139F calculates, on the basis of the frame image PF2 subsequent to the frame image PF1, the average burn-in level in a case where the liquid crystal light valve 20R performs the first operation, and the average burn-in level in a case where the liquid crystal light valve 20R performs the second operation. Similarly, the estimator 139F calculates, on the basis of the frame image PF2, the average burn-in level in a case where the liquid crystal light valve 20G performs the first operation, and the average burn-in level in a case where the liquid crystal light valve 20G performs the second operation. The estimator 139F calculates, on the basis of the frame image PF2, the average burn-in level in a case where the liquid crystal light valve 20B performs the first operation, and the average burn-in level in a case where the liquid crystal light valve 20B performs the second operation. Further, for example, the estimator 139F selects the operation that makes it possible to reduce burn-in in the liquid crystal light valves 20R, 20G, and 20B, out of the first operation and the second operation, on the basis of the three average burn-in levels related to the frame image PF1, the three average burn-in levels in the case where the first operation is performed, related to the frame image PF2, and the three average burn-in levels in the case where the second operation is performed, related to the frame image PF2.

In a case where it is determined that the first operation is to be performed, the display controller 38F supplies the sub-images PA, PB, PC, and PD related to red in this order to the liquid crystal light valve 20R, supplies the sub-images PA, PB, PC, and PD related to green in this order to the liquid crystal light valve 20G, and supplies the sub-images PA, PB, PC, and PD related to blue in this order to the liquid crystal light valve 20R. In addition, in a case where it is determined that the second operation is to be performed, the display controller 38F supplies the sub-images PB, PA, PD, and PC related to red in this order to the liquid crystal light valve 20R, supplies the sub-images PB, PA, PD, and PC related to green in this order to the liquid crystal light valve 20G, and supplies the sub-images PB, PA, PD, and PC related to blue in this order to the liquid crystal light valve 20R.

### Modification Example 1-7

In the first embodiment described above, the projection display apparatus 1 includes the three transmissive liquid crystal light valves 20R, 20G, and 20B, but this is non-limiting. Alternatively, for example, the projection display apparatus 1 may include three reflective liquid crystal light valves.

### Other Modification Examples

In addition, two or more of these modification examples may be combined.

### 2. Second Embodiment

Described next is a projection display apparatus 2 according to a second embodiment. In the present embodiment, some of the four sub-images PA to PD are displayed. Note that components substantially the same as those of the projection display apparatus 1 according to the first embodiment described above are denoted by the same reference numerals, and description thereof is omitted as appropriate.

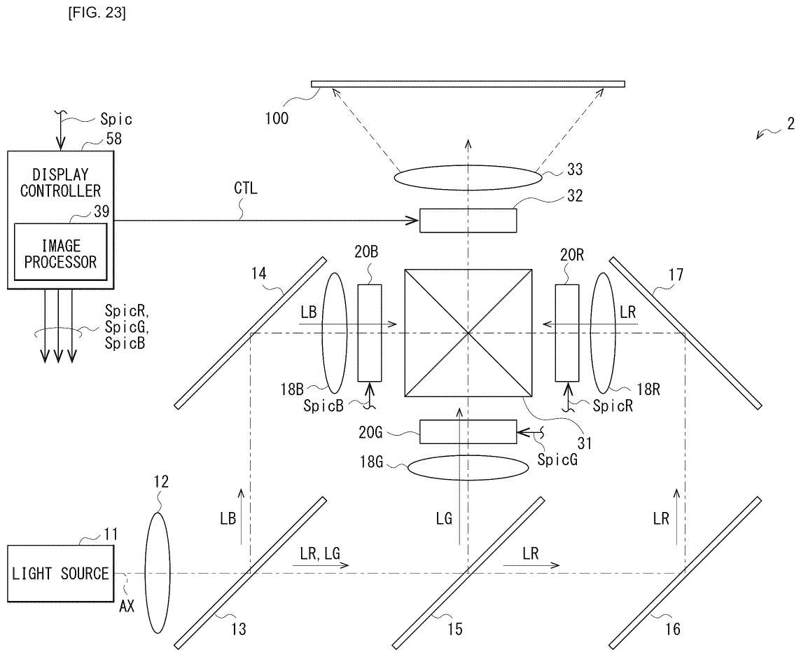

FIG. 23 illustrates a configuration example of the projection display apparatus 2. The projection display apparatus 2 includes a display controller 58. The display controller 58 supplies the image signal SpicR including image data of three sub-images to be displayed, out of the four sub-images PA, PB, PC, and PD related to red generated by the image processor 39, to the liquid crystal light valve 20R, supplies the image signal SpicG including image data of three sub-images to be displayed, out of the four sub-images PA, PB, PC, and PD related to green generated by the image processor 39, to the liquid crystal light valve 20G, and supplies the image signal SpicB including image data of three sub-images to be displayed, out of the four sub-images PA, PB, PC, and PD related to blue generated by the image processor 39, to the liquid crystal light valve 20B.

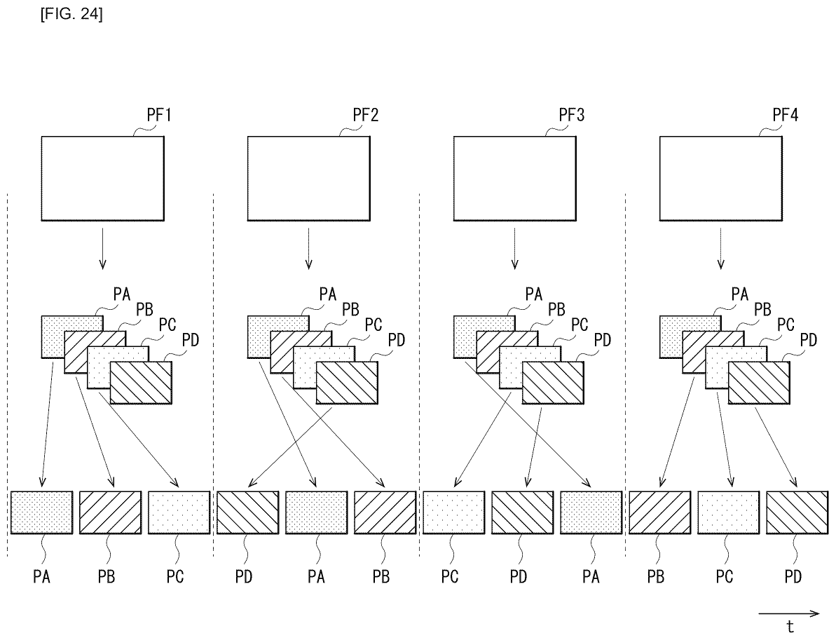

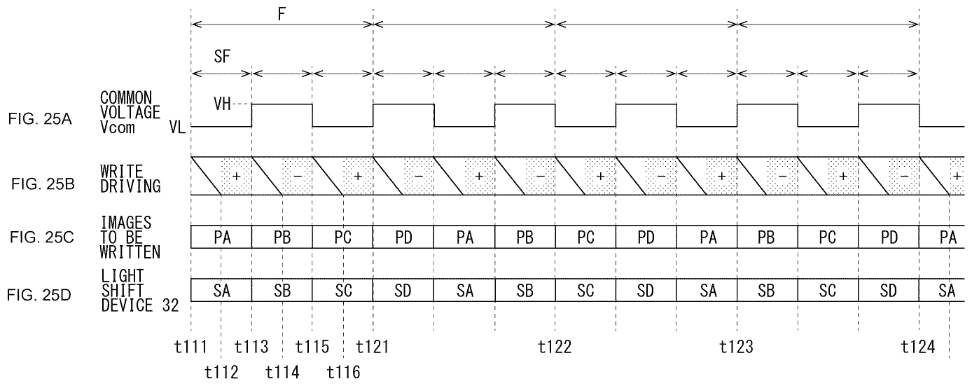

FIG. 24 illustrates an operation example of the image processor 39 in the projection display apparatus 2. FIG. 25 illustrates an operation example of the projection display apparatus 2, in which (A) illustrates a waveform of the common voltage Vcom in the liquid crystal light valves 20R, 20G, and 20B, (B) illustrates write driving in the liquid crystal light valves 20R, 20G, and 20B, (C) illustrates images to be written in the liquid crystal light valves 20R, 20G, and 20B, and (D) illustrates the operation state in the light shift device 32. In this example, the light source 11 keeps emitting white light. In this example, the frame period F has a length of 16.7 [msec.] (= 1/60 [Hz]).

First, as illustrated in FIG. 24, the first frame image PF (the frame image PF1) is supplied to the projection display apparatus 2 by using the image signal Spic. The image processor 39 generates the four sub-images PA to PD on the basis of the frame image PF1, and the display controller 58 supplies the three sub-images PA, PB, and PC, out of the four sub-images PA to PD, in this order to the liquid crystal light valves 20R, 20G, and 20B.

Specifically, the image processor 39 generates the four sub-images PA to PD related to red on the basis of the frame image PF1 related to red, generates the four sub-images PA to PD related to green on the basis of the frame image PF1 related to green, and generates the four sub-images PA to PD related to blue on the basis of the frame image PF1 related to blue. Further, the display controller 58 supplies the sub-images PA, PB, and PC related to red to the liquid crystal light valve 20R by using the image signal SpicR, supplies the sub-images PA, PB, and PC related to green to the liquid crystal light valve 20G by using the image signal SpicG, and supplies the sub-images PA, PB, and PC related to blue to the liquid crystal light valve 20B by using the image signal SpicB.

Further, as illustrated in FIG. 25, the projection display apparatus 2 displays the sub-image PA, the sub-image PB, and the sub-image PC in this order, in the frame period F from timing t111 to timing t121.

Specifically, in the sub-frame period SF from timing t111 to timing t113, for example, the liquid crystal light valve 20R sets the common voltage Vcom to the voltage VL ((A) of FIG. 25), and performs line-sequential scanning from the top to the bottom of the pixel array 21 to thereby perform write driving in a period from timing t111 to timing t112 ((B) of FIG. 25). In the write driving, the liquid crystal light valve 20R writes the pixel voltage Vpix with the positive polarity to each of the pixels P, on the basis of the sub-image PA related to red ((B) and (C) of FIG. 25). A time length from timing t111 to timing t112 is shorter than the time length of the sub-frame period SF and may be, for example, about ⅙ of the time length of the frame period F. In a period from timing t112 to timing t113, the voltage difference ΔV between the voltage of the pixel electrode 41 and the voltage of the common electrode 43 is set to a voltage difference based on the sub-image PA related to red, in all the pixels P from the top to the bottom of the pixel array 21, as indicated by hatching in (B) of FIG. 25. The same applies to the operations of the liquid crystal light valves 20G and 20B. In this manner, the liquid crystal light valves 20R, 20G, and 20B emit image light corresponding to the sub-image PA.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PA. In the period from timing t111 to timing t113, the light shift device 32 sets the operation state to the operation state SA, on the basis of the control signal CTL ((D) of FIG. 25). The projection display apparatus 2 projects the combined image light emitted from the cross prism 31 and shifted by the light shift device 32 onto the screen 100.

In addition, in the sub-frame period SF from timing t113 to timing t115, for example, the liquid crystal light valve 20R sets the common voltage Vcom to the voltage VH ((A) of FIG. 25), and performs line-sequential scanning from the top to the bottom of the pixel array 21 to thereby perform write driving in a period from timing t113 to timing t114 ((B) of FIG. 25). In the write driving, the liquid crystal light valve 20R writes the pixel voltage Vpix with the negative polarity to each of the pixels P, on the basis of the sub-image PB related to red ((B) and (C) of FIG. 25). A time length from timing t113 to timing t114 is shorter than the time length of the sub-frame period SF and may be, for example, about ⅙ of the time length of the frame period F. In a period from timing t114 to timing t115, the voltage difference ΔV between the voltage of the pixel electrode 41 and the voltage of the common electrode 43 is set to a voltage difference based on the sub-image PB related to red, in all the pixels P from the top to the bottom of the pixel array 21, as indicated by hatching in (B) of FIG. 25. The same applies to the operations of the liquid crystal light valves 20G and 20B. In this manner, the liquid crystal light valves 20R, 20G, and 20B emit image light corresponding to the sub-image PB.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PB. In the period from timing t113 to timing t115, the light shift device 32 sets the operation state to the operation state SB, on the basis of the control signal CTL ((D) of FIG. 10). The projection display apparatus 2 projects the combined image light emitted from the cross prism 31 and shifted by the light shift device 32 onto the screen 100.

In addition, in the sub-frame period SF from timing t115 to timing t121, for example, the liquid crystal light valve 20R sets the common voltage Vcom to the voltage VL ((A) of FIG. 25), and performs line-sequential scanning from the top to the bottom of the pixel array 21 to thereby perform write driving in a period from timing t115 to timing t116 ((B) of FIG. 25). In the write driving, the liquid crystal light valve 20R writes the pixel voltage Vpix with the positive polarity to each of the pixels P, on the basis of the sub-image PC related to red ((B) and (C) of FIG. 25). A time length from timing t115 to timing t116 is shorter than the time length of the sub-frame period SF and may be, for example, about ⅙ of the time length of the frame period F. In a period from timing t116 to timing t121, the voltage difference ΔV between the voltage of the pixel electrode 41 and the voltage of the common electrode 43 is set to a voltage difference based on the sub-image PC related to red, in all the pixels P from the top to the bottom of the pixel array 21, as indicated by hatching in (B) of FIG. 25. The same applies to the operations of the liquid crystal light valves 20G and 20B. In this manner, the liquid crystal light valves 20R, 20G, and 20B emit image light corresponding to the sub-image PC.

The cross prism 31 combines the red image light generated by the liquid crystal light valve 20R, the green image light generated by the liquid crystal light valve 20G, and the blue image light generated by the liquid crystal light valve 20B, to thereby generate the combined image light for the sub-image PC. In the period from timing t115 to timing t121, the light shift device 32 sets the operation state to the operation state SC, on the basis of the control signal CTL ((D) of FIG. 25). The projection display apparatus 2 projects the combined image light emitted from the cross prism 31 and shifted by the light shift device 32 onto the screen 100.

In this manner, the projection display apparatus 2 displays the sub-image PA, the sub-image PB, and the sub-image PC in this order, in the frame period F from timing t111 to timing t121, as illustrated in FIG. 25.

Next, as illustrated in FIG. 24, the second frame image PF (the frame image PF2) is supplied to the projection display apparatus 2 by using the image signal Spic. The image processor 39 generates the four sub-images PA to PD on the basis of the frame image PF2, and the display controller 58 supplies the three sub-images PD, PA, and PB, out of the four sub-images PA to PD, in this order to the liquid crystal light valves 20R, 20G, and 20B. As illustrated in FIG. 25, in the frame period F from timing t121 to timing t122, the liquid crystal light valve 20R sets the common voltage Vcom to the voltage VH and writes the pixel voltage Vpix with the negative polarity to each of the pixels P on the basis of the sub-image PD, sets the common voltage Vcom to the voltage VL and writes the pixel voltage Vpix with the positive polarity to each of the pixels P on the basis of the sub-image PA, and sets the common voltage Vcom to the voltage VH and writes the pixel voltage Vpix with the negative polarity to each of the pixels P on the basis of the sub-image PB, as with the operation in the frame period F from timing t111 to timing t121. The same applies to the liquid crystal light valves 20G and 20B. In this manner, the projection display apparatus 2 displays the sub-image PD, the sub-image PA, and the sub-image PB in this order.

Next, as illustrated in FIG. 24, the third frame image PF (the frame image PF3) is supplied to the projection display apparatus 2 by using the image signal Spic. The image processor 39 generates the four sub-images PA to PD on the basis of the frame image PF3, and the display controller 58 supplies the three sub-images PC, PD, and PA, out of the four sub-images PA to PD, in this order to the liquid crystal light valves 20R, 20G, and 20B. As illustrated in FIG. 25, in the frame period F from timing t122 to timing t123, the liquid crystal light valve 20R sets the common voltage Vcom to the voltage VL and writes the pixel voltage Vpix with the positive polarity to each of the pixels P on the basis of the sub-image PC, sets the common voltage Vcom to the voltage VH and writes the pixel voltage Vpix with the negative polarity to each of the pixels P on the basis of the sub-image PD, and sets the common voltage Vcom to the voltage VL and writes the pixel voltage Vpix with the positive polarity to each of the pixels P on the basis of the sub-image PA, as with the operation in the frame period F from timing t111 to timing t121. The same applies to the liquid crystal light valves 20G and 20B. In this manner, the projection display apparatus 2 displays the sub-image PC, the sub-image PD, and the sub-image PA in this order.

Next, as illustrated in FIG. 24, the fourth frame image PF (the frame image PF4) is supplied to the projection display apparatus 2 by using the image signal Spic. The image processor 39 generates the four sub-images PA to PD on the basis of the frame image PF4, and the display controller 58 supplies the three sub-images PB, PC, and PD, out of the four sub-images PA to PD, in this order to the liquid crystal light valves 20R, 20G, and 20B. As illustrated in FIG. 25, in the frame period F from timing t123 to timing t124, the liquid crystal light valve 20R sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as with the operation in the frame period F from timing t111 to timing t121. The same applies to the liquid crystal light valves 20G and 20B. In this manner, the projection display apparatus 2 displays the sub-image PB, the sub-image PC, and the sub-image PD in this order.

As described above, in the projection display apparatus 2, three sub-images out of the four sub-images PA to PD are displayed in the frame period F. Thus, as compared with a case of displaying the four sub-images PA to PD in the frame period F, as in the case of the first embodiment described above (FIG. 10), it is possible to reduce the number of the sub-frame periods SF in the frame period F, which makes it possible to reduce an operation frequency of the liquid crystal light valves 20R, 20G, and 20B.

In addition, in the projection display apparatus 2, the four sub-images PA to PD are displayed in two frame periods F adjacent to each other. For example, in a case where the projection display apparatus 2 displays a still image, the first frame image PF1 and the second frame image PF2 are the same as each other. Accordingly, the projection display apparatus 2 makes it possible to display an image with high image quality without loss of the image, by displaying the sub-images PA, PB, and PC generated on the basis of the frame image PF1 and the sub-image PD generated on the basis of the frame image PF2. In addition, for example, in a case where the projection display apparatus 2 displays a moving image, for example, the image can partially be lost because the sub-image PD generated on the basis of the first frame image PF1 is not displayed. However, such loss of the image is less likely to be visually recognized in a moving image in general. Accordingly, the projection display apparatus 2 makes it possible to suppress a decrease in image quality in a case of displaying a moving image.

As described above, the projection display apparatus 2 includes the display controller 38, the first optical system, the liquid crystal light valve (e.g., the liquid crystal light valve 20R), the light shift device 32, and the second optical system. The display controller 38 is configured to generate, on the basis of the frame image PF, three sub-images that are some of the four sub-images PA to PD each including the multiple pixel values arranged in the predetermined arrangement pattern in the frame image PF. The first optical system includes the light source 11 configured to emit light. The liquid crystal light valve (e.g., the liquid crystal light valve 20R) includes the multiple pixels P, and is configured to selectively perform the first driving of driving the multiple pixels P by using the pixel voltage Vpix with the first polarity or the second driving of driving the multiple pixels by using the pixel voltage Vpix with the second polarity, on the basis of the three sub-images, and modulate the light from the first optical system to thereby generate image light. The light shift device 32 is configured to shift the image light in the in-plane direction of the image, depending on image light of which sub-image out of the four sub-images PA to PD the image light is. The second optical system is configured to project the image light processed by the light shift device 32. The liquid crystal light valve (e.g., the liquid crystal light valve 20R) is configured to selectively perform the first driving or the second driving, on the basis of one of the three sub-images, in the predetermined driving cycle corresponding to the sub-frame period SF, and write the multiple pixel voltages Vpix to the respective multiple pixels P in the write period shorter than the driving cycle. Thus, the projection display apparatus 2 makes it possible to reduce the number of the sub-frame periods SF in the frame period F, which makes it possible to reduce the operation frequency of the liquid crystal light valves 20R, 20G, and 20B.

As described above, in the present embodiment, the display controller, the first optical system, the liquid crystal light valve, the light shift device, and the second optical system are included. The display controller is configured to generate, on the basis of the frame image, three sub-images that are some of the four sub-images each including the multiple pixel values arranged in the predetermined arrangement pattern in the frame image. The first optical system includes the light source configured to emit light. The liquid crystal light valve includes the multiple pixels, and is configured to selectively perform the first driving of driving the multiple pixels by using the pixel voltage with the first polarity or the second driving of driving the multiple pixels by using the pixel voltage with the second polarity, on the basis of each of the three sub-images, and modulate the light from the first optical system to thereby generate image light. The light shift device is configured to shift the image light in the in-plane direction of the image, depending on image light of which sub-image out of the four sub-images the image light is. The second optical system is configured to project the image light processed by the light shift device. The liquid crystal light valve is configured to selectively perform the first driving or the second driving, on the basis of one of the four sub-images, in the predetermined driving cycle corresponding to the sub-frame period, and write the multiple pixel voltages to the respective multiple pixels in the write period shorter than the driving cycle. This makes it possible to reduce the operation frequency of the liquid crystal light valve. Other effects are similar to those in the case of the first embodiment described above.

### Modification Example 2-1

In the second embodiment described above, the common voltage Vcom that is the alternating-current voltage is applied to the common electrode 43, but this is non-limiting. Alternatively, for example, the common voltage Vcom that is the direct-current voltage may be applied to the common electrode 43, as in the case of Modification Example 1-1 related to the first embodiment described above (FIGS. 12 and 13).

### Modification Example 2-2

In the second embodiment described above, for example, the sub-image PA, the sub-image PB, and the sub-image PC are displayed in this order in the first frame period F, the sub-image PD, the sub-image PA, and the sub-image PB are displayed in this order in the subsequent frame period F, the sub-image PC, the sub-image PD, and the sub-image PA are displayed in this order in the subsequent frame period F, and the sub-image PB, the sub-image PC, and the sub-image PD are displayed in this order in the subsequent frame period F, but this is non-limiting, and the display order of the sub-images may be another order. Specifically, for example, the sub-image PA, the sub-image PD, and the sub-image PC may be displayed in this order in the first frame period F, the sub-image PB, the sub-image PA, and the sub-image PD may be displayed in this order in the subsequent frame period F, the sub-image PC, the sub-image PB, and the sub-image PA may be displayed in this order in the subsequent frame period F, and the sub-image PD, the sub-image PC, and the sub-image PB may be displayed in this order in the subsequent frame period F.

### Modification Example 2-3

In the second embodiment described above, the light source 11 keeps emitting white light, but this is non-limiting. For example, in a case where the light source 11 includes a light-emitting diode, a laser light source, or the like, the light source 11 may emit light and stop emitting light in accordance with line-sequential scanning in the liquid crystal light valves 20R, 20G, and 20B, as in the case of Modification Example 1-3 related to the first embodiment described above (FIG. 14).

### Modification Example 2-4

In the second embodiment described above, the multiple pixels P are driven by the same driving method in each of the frame periods F, but this is non-limiting. Alternatively, for example, the driving method may be switched in units of four sub-frame periods SF. The present modification example is described in detail below.

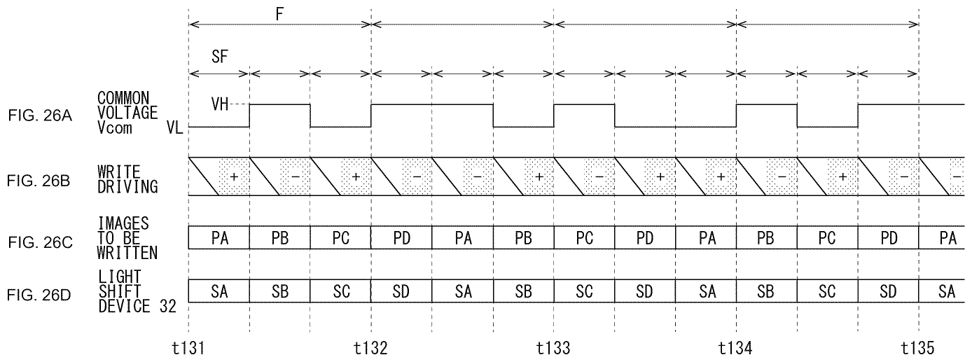

FIG. 26 illustrates an operation example of the projection display apparatus 2 according to the present modification example.

First, the first frame image PF (the frame image PF1) is supplied to the projection display apparatus 2 by using the image signal Spic, as in the case of the second embodiment described above (FIG. 24). The image processor 39 generates the four sub-images PA to PD on the basis of the frame image PF1, and the display controller 58 supplies the three sub-images PA, PB, and PC, out of the four sub-images PA to PD, in this order to the liquid crystal light valves 20R, 20G, and 20B. In the frame period F from timing t131 to timing t132, the liquid crystal light valve 20R sets the common voltage Vcom to the voltage VL and writes the pixel voltage Vpix with the positive polarity to each of the pixels P on the basis of the sub-image PA, sets the common voltage Vcom to the voltage VH and writes the pixel voltage Vpix with the negative polarity to each of the pixels P on the basis of the sub-image PB, and sets the common voltage Vcom to the voltage VL and writes the pixel voltage Vpix with the positive polarity to each of the pixels P on the basis of the sub-image PC, as in the case of the second embodiment described above. The same applies to the liquid crystal light valves 20G and 20B. In this manner, the projection display apparatus 2 displays the sub-image PA, the sub-image PB, and the sub-image PC in this order.

Next, the second frame image PF (the frame image PF2) is supplied to the projection display apparatus 2 by using the image signal Spic, as in the case of the second embodiment described above (FIG. 24). The image processor 39 generates the four sub-images PA to PD on the basis of the frame image PF2, and the display controller 58 supplies the three sub-images PD, PA, and PB, out of the four sub-images PA to PD, in this order to the liquid crystal light valves 20R, 20G, and 20B. In the frame period F from timing t132 to timing t133, the liquid crystal light valve 20R sets the common voltage Vcom to the voltage VH and writes the pixel voltage Vpix with the negative polarity to each of the pixels P on the basis of the sub-image PD, sets the common voltage Vcom to the voltage VH and writes the pixel voltage Vpix with the negative polarity to each of the pixels P on the basis of the sub-image PA, and sets the common voltage Vcom to the voltage VL and writes the pixel voltage Vpix with the positive polarity to each of the pixels P on the basis of the sub-image PB, as in the case of the second embodiment described above. The same applies to the liquid crystal light valves 20G and 20B. In this manner, the projection display apparatus 2 displays the sub-image PA, the sub-image PB, and the sub-image PC in this order.

Next, the third frame image PF (the frame image PF3) is supplied to the projection display apparatus 2 by using the image signal Spic, as in the case of the second embodiment described above (FIG. 24). The image processor 39 generates the four sub-images PA to PD on the basis of the frame image PF3, and the display controller 58 supplies the three sub-images PC, PD, and PA, out of the four sub-images PA to PD, in this order to the liquid crystal light valves 20R, 20G, and 20B. In the frame period F from timing t133 to timing t134, the liquid crystal light valve 20R sets the common voltage Vcom to the voltage VH and writes the pixel voltage Vpix with the negative polarity to each of the pixels P on the basis of the sub-image PC, sets the common voltage Vcom to the voltage VL and writes the pixel voltage Vpix with the positive polarity to each of the pixels P on the basis of the sub-image PD, and sets the common voltage Vcom to the voltage VL and writes the pixel voltage Vpix with the positive polarity to each of the pixels P on the basis of the sub-image PA, as in the case of the second embodiment described above. The same applies to the liquid crystal light valves 20G and 20B. In this manner, the projection display apparatus 2 displays the sub-image PC, the sub-image PD, and the sub-image PA in this order.

Next, the fourth frame image PF (the frame image PF4) is supplied to the projection display apparatus 2 by using the image signal Spic, as in the case of the second embodiment described above (FIG. 24). The image processor 39 generates the four sub-images PA to PD on the basis of the frame image PF4, and the display controller 58 supplies the three sub-images PB, PC, and PD, out of the four sub-images PA to PD, in this order to the liquid crystal light valves 20R, 20G, and 20B. In the frame period F from timing t134 to timing t135, the liquid crystal light valve 20R sets the common voltage Vcom to the voltage VH and writes the pixel voltage Vpix with the negative polarity to each of the pixels P on the basis of the sub-image PB, sets the common voltage Vcom to the voltage VL and writes the pixel voltage Vpix with the positive polarity to each of the pixels P on the basis of the sub-image PC, and sets the common voltage Vcom to the voltage VH and writes the pixel voltage Vpix with the negative polarity to each of the pixels P on the basis of the sub-image PD, as in the case of the second embodiment described above. The same applies to the liquid crystal light valves 20G and 20B. In this manner, the projection display apparatus 2 displays the sub-image PB, the sub-image PC, and the sub-image PD in this order.

Also in this case, it is possible to suppress burn-in as in the case of Modification Example 1-4 related to the first embodiment described above (FIG. 15).

### Modification Example 2-5

In the second embodiment described above, driving in the positive polarity and driving in the negative polarity are alternately repeated in units of the sub-frame period SF, but this is non-limiting. Alternatively, driving in the positive polarity and driving in the negative polarity may be alternately repeated in units of multiple sub-frame periods SF. The present modification example is described in detail below.

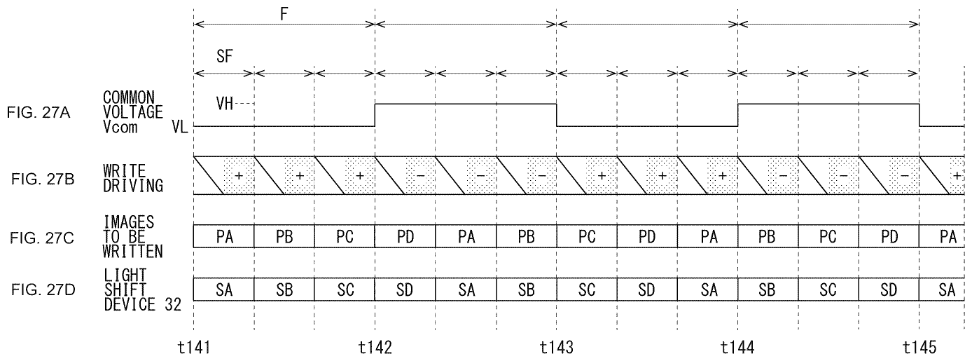

FIG. 27 illustrates an operation example of the projection display apparatus 2 according to the present modification example. In this example, the projection display apparatus 2 alternately repeats driving in the positive polarity and driving in the negative polarity in units of the frame period F. For example, in a period from timing t141 to timing t142, the liquid crystal light valve 20R keeps the common voltage Vcom at the voltage VL. Further, the liquid crystal light valve 20R writes the pixel voltage Vpix with the positive polarity to each of the pixels P on the basis of the sub-image PA, writes the pixel voltage Vpix with the positive polarity to each of the pixels P on the basis of the sub-image PB, and writes the pixel voltage Vpix with the positive polarity to each of the pixels P on the basis of the sub-image PC. In addition, for example, in a period from timing t142 to timing t143, the liquid crystal light valve 20R keeps the common voltage Vcom at the voltage VH. Further, the liquid crystal light valve 20R writes the pixel voltage Vpix with the negative polarity to each of the pixels P on the basis of the sub-image PD, writes the pixel voltage Vpix with the negative polarity to each of the pixels P on the basis of the sub-image PA, and writes the pixel voltage Vpix with the negative polarity to each of the pixels P on the basis of the sub-image PB. In addition, for example, in a period from timing t143 to timing t144, the liquid crystal light valve 20R keeps the common voltage Vcom at the voltage VL. Further, the liquid crystal light valve 20R writes the pixel voltage Vpix with the positive polarity to each of the pixels P on the basis of the sub-image PC, writes the pixel voltage Vpix with the positive polarity to each of the pixels P on the basis of the sub-image PD, and writes the pixel voltage Vpix with the positive polarity to each of the pixels P on the basis of the sub-image PA. In addition, for example, in a period from timing t144 to timing t145, the liquid crystal light valve 20R keeps the common voltage Vcom at the voltage VH. Further, the liquid crystal light valve 20R writes the pixel voltage Vpix with the negative polarity to each of the pixels P on the basis of the sub-image PB, writes the pixel voltage Vpix with the negative polarity to each of the pixels P on the basis of the sub-image PC, and writes the pixel voltage Vpix with the negative polarity to each of the pixels P on the basis of the sub-image PD. Also in this case, it is possible to suppress burn-in as in the case of Modification Example 1-4 related to the first embodiment described above (FIG. 15).

### Modification Example 2-6

In the second embodiment described above, three sub-images out of the four sub-images PA to PD are displayed in the frame period F, but this is non-limiting. Alternatively, for example, two sub-images out of the four sub-images PA to PD may be displayed in the frame period F.

### Modification Example 2-7

In the second embodiment described above, the projection display apparatus 2 generates the four sub-images PA to PD on the basis of the frame image PF, and supplies three sub-images to be displayed out of the four sub-images PA to PD to the liquid crystal light valves 20R, 20G, and 20B, but this is non-limiting. Alternatively, for example, the projection display apparatus 2 may generate the three sub-images to be displayed out of the four sub-images PA to PD on the basis of the frame image PF. That is, because the sub-image other than the three sub-images to be displayed out of the four sub-images PA to PD is not used, the projection display apparatus 2 may generate the three sub-images to be displayed, and refrain from generating the sub-image other than the three sub-images to be displayed.

### Modification Example 2-8

In the first embodiment described above, the projection display apparatus 2 includes the three transmissive liquid crystal light valves 20R, 20G, and 20B, but this is non-limiting. Alternatively, for example, the projection display apparatus 2 may include three reflective liquid crystal light valves.

### Other Modification Examples

In addition, two or more of these modification examples may be combined.

### 3. Application Examples

Although the present technology is applied to the projector in the above description, without being limited thereto, the present technology is applicable to various display apparatuses.

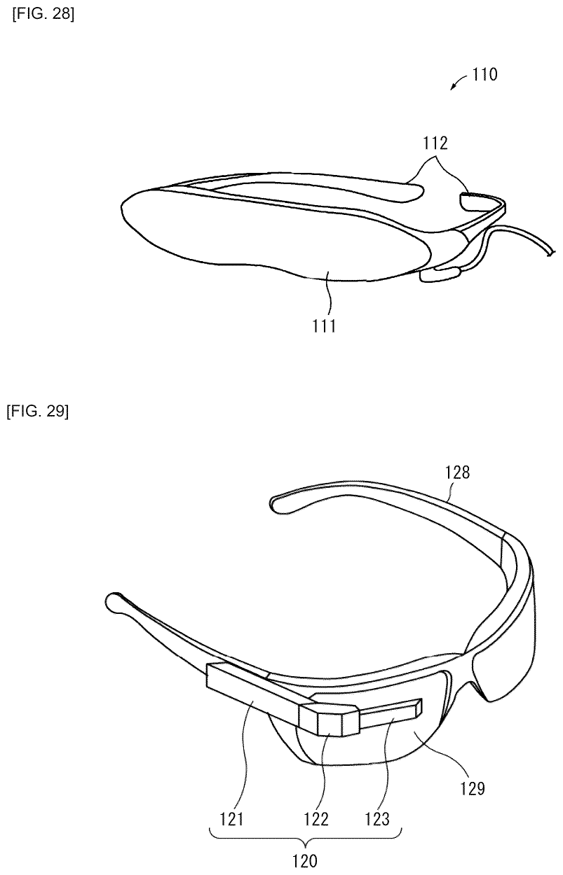

FIG. 28 illustrates an example of an appearance of a head-mounted display 110. The head-mounted display 110 includes, for example, ear hook sections 112 for mounting on the head of a user on both sides of a glasses-shaped display section 111. Such a head-mounted display 120 makes it possible to achieve virtual reality (VR), for example. The technology according to the embodiments and the like described above is applicable to such a head-mounted display 110.

FIG. 29 illustrates an example of an appearance of another head-mounted display 120. The head-mounted display 120 is a see-through head-mounted display including a main body section 121, an arm section 122, and a barrel section 123. The head-mounted display 120 is mounted on glasses 128. The main body section 121 includes a control substrate for control of an operation of the head-mounted display 120, and a display section. This display section emits image light of a display image. The arm section 122 couples the main body section 121 and the barrel section 123 to each other, and supports the barrel section 123. The barrel section 123 projects the image light supplied from the main body section 121 through the arm section 122 toward a user's eye through a lens 129 of the glasses 128. Such a head-mounted display 120 makes it possible to achieve augmented reality (AR), for example. The technology according to the embodiments and the like described above is applicable to such a head-mounted display 120.

Although the present technology has been described above with reference to some embodiments and modification examples and application examples thereof to electronic apparatuses, the present technology is not limited to these embodiments and the like, and may be modified in a variety of ways.

For example, in the embodiments and the like described above, the light shift device has the four operation states SA to SD, but this is non-limiting. Alternatively, for example, the light shift device may have two or three operation states, or may have five or more operation states.

It is to be noted that the effects described herein are merely exemplary and are not limitative, and may further include other effects.

The present technology may also have the following configurations. According to the present technology having the following configurations, it is possible to improve image quality.
(1)

A projection display apparatus including:
a display controller configured to generate, on the basis of a frame image, two or more sub-images that are some or all of multiple sub-images each including multiple pixel values arranged in a predetermined arrangement pattern in the frame image;
a first optical system including a light source configured to emit light;
a liquid crystal light valve including multiple pixels, and configured to selectively perform first driving of driving the multiple pixels by using a pixel voltage with a first polarity or second driving of driving the multiple pixels by using a pixel voltage with a second polarity, on the basis of each of the two or more sub-images, and modulate the light from the first optical system to thereby generate image light;
a light shift device configured to shift the image light in an in-plane direction of an image, depending on image light of which sub-image out of the multiple sub-images the image light is; and
a second optical system configured to project the image light processed by the light shift device, in which
the liquid crystal light valve is configured to
   selectively perform the first driving or the second driving, on the basis of one of the two or more sub-images, in a predetermined driving cycle, and
   write multiple pixel voltages to the respective multiple pixels in a write period shorter than the driving cycle.
(2)

The projection display apparatus according to (1), in which
the display controller is configured to generate the two or more sub-images that are all of the multiple sub-images.
(3)

The projection display apparatus according to (2), in which
the liquid crystal light valve is configured to alternately repeat the first driving and the second driving, in units of the driving cycle.
(4)

The projection display apparatus according to (2), in which
the liquid crystal light valve is configured to
   repeat the first driving and the second driving in this order, in units of the driving cycle, in a first frame period of performing display on the basis of the two or more sub-images corresponding to a first frame image, and
   repeat the second driving and the first driving in this order, in units of the driving cycle, in a second frame period of performing display on the basis of the two or more sub-images corresponding to a second frame image subsequent to the first frame image.
(5)

The projection display apparatus according to (2), in which
the liquid crystal light valve is configured to alternately repeat the first driving and the second driving, in units of a frame period of performing display on the basis of the two or more sub-images corresponding to the frame image.
(6)

The projection display apparatus according to (2), in which
the liquid crystal light valve is configured to alternately repeat the first driving and the second driving, in units of a plurality of the driving cycles.
(7)

The projection display apparatus according to (2), in which
the liquid crystal light valve is configured to alternately repeat the first driving and the second driving, in units of the driving cycle, and
the display controller is configured to change a display order of the multiple sub-images in generating the image light on the basis of the multiple sub-images, in units of a frame period of performing display on the basis of the multiple sub-images corresponding to the frame image.
(8)

The projection display apparatus according to (7), in which
the two or more sub-images corresponding to a first frame image include a first sub-image and a second sub-image,
the two or more sub-images corresponding to a second frame image include a first sub-image and a second sub-image, and
the liquid crystal light valve is configured to
   perform the first driving on the basis of the first sub-image corresponding to the first frame image,
   perform the second driving on the basis of the second sub-image corresponding to the first frame image,
   perform the second driving on the basis of the first sub-image corresponding to the second frame image, and
   perform the first driving on the basis of the second sub-image corresponding to the second frame image.
(9)

The projection display apparatus according to (7) or (8), in which
the display controller is configured to change the display order of the multiple sub-images, on the basis of the pixel values of the multiple sub-images.
(10)

The projection display apparatus according to (1), in which
the display controller is configured to generate the two or more sub-images that are some of the multiple sub-images.
(11)

The projection display apparatus according to (10), in which
the liquid crystal light valve is configured to alternately repeat the first driving and the second driving, in units of the driving cycle.
(12)

The projection display apparatus according to (10), in which
the liquid crystal light valve is configured to
   repeat the first driving and the second driving in this order, in units of the driving cycle, in a first period of displaying a predetermined number of sub-images that are same in number as the multiple sub-images, and
   repeat the second driving and the first driving in this order, in units of the driving cycle, in a second period of displaying the predetermined number of sub-images, subsequent to the first period.
(13)

The projection display apparatus according to (10), in which
the liquid crystal light valve is configured to alternately repeat the first driving and the second driving, in units of a frame period of performing display on the basis of the two or more sub-images corresponding to the frame image.
(14)

The projection display apparatus according to any one of (1) to (13), in which
the multiple sub-images include multiple pixel values arranged in multiple arrangement patterns different from each other,
the multiple arrangement patterns include a first arrangement pattern, a second arrangement pattern, a third arrangement pattern, and a fourth arrangement pattern, and
the display controller is configured to generate, on the basis of the frame image, the two or more sub-images that are some or all of a first sub-image including multiple pixel values arranged in the first arrangement pattern, a second sub-image including multiple pixel values arranged in the second arrangement pattern, a third sub-image including multiple pixel values arranged in the third arrangement pattern, and a fourth sub-image including multiple pixel values arranged in the fourth arrangement pattern.

This application claims the benefit of Japanese Priority Patent Application JP2023-082838 filed with the Japan Patent Office on May 19, 2023, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A projection display apparatus comprising:
a display controller configured to generate, on a basis of a frame image, two or more sub-images that are some or all of multiple sub-images each including multiple pixel values arranged in a predetermined arrangement pattern in the frame image;
a first optical system including a light source configured to emit light;
a liquid crystal light valve including multiple pixels, and configured to selectively perform first driving of driving the multiple pixels by using a pixel voltage with a first polarity or second driving of driving the multiple pixels by using a pixel voltage with a second polarity, on a basis of each of the two or more sub-images, and modulate the light from the first optical system to thereby generate image light;
a light shift device configured to shift the image light in an in-plane direction of an image, depending on image light of which sub-image out of the multiple sub-images the image light is; and
a second optical system configured to project the image light processed by the light shift device, wherein
the liquid crystal light valve is configured to
selectively perform the first driving or the second driving, on a basis of one of the two or more sub-images, in a predetermined driving cycle, and
write multiple pixel voltages to the respective multiple pixels in a write period shorter than the driving cycle.

2. The projection display apparatus according to claim 1, wherein
the display controller is configured to generate the two or more sub-images that are all of the multiple sub-images.

3. The projection display apparatus according to claim 2, wherein
the liquid crystal light valve is configured to alternately repeat the first driving and the second driving, in units of the driving cycle.

4. The projection display apparatus according to claim 2, wherein
the liquid crystal light valve is configured to
repeat the first driving and the second driving in this order, in units of the driving cycle, in a first frame period of performing display on a basis of the two or more sub-images corresponding to a first frame image, and
repeat the second driving and the first driving in this order, in units of the driving cycle, in a second frame period of performing display on a basis of the two or more sub-images corresponding to a second frame image subsequent to the first frame image.

5. The projection display apparatus according to claim 2, wherein
the liquid crystal light valve is configured to alternately repeat the first driving and the second driving, in units of a frame period of performing display on a basis of the two or more sub-images corresponding to the frame image.

6. The projection display apparatus according to claim 2, wherein
the liquid crystal light valve is configured to alternately repeat the first driving and the second driving, in units of a plurality of the driving cycles.

7. The projection display apparatus according to claim 2, wherein
the liquid crystal light valve is configured to alternately repeat the first driving and the second driving, in units of the driving cycle, and
the display controller is configured to change a display order of the multiple sub-images in generating the image light on a basis of the multiple sub-images, in units of a frame period of performing display on a basis of the multiple sub-images corresponding to the frame image.

8. The projection display apparatus according to claim 7, wherein
the two or more sub-images corresponding to a first frame image include a first sub-image and a second sub-image,
the two or more sub-images corresponding to a second frame image include a first sub-image and a second sub-image, and
the liquid crystal light valve is configured to
perform the first driving on a basis of the first sub-image corresponding to the first frame image,
perform the second driving on a basis of the second sub-image corresponding to the first frame image,
perform the second driving on a basis of the first sub-image corresponding to the second frame image, and
perform the first driving on a basis of the second sub-image corresponding to the second frame image.

9. The projection display apparatus according to claim 7, wherein
the display controller is configured to change the display order of the multiple sub-images, on a basis of the pixel values of the multiple sub-images.

10. The projection display apparatus according to claim 1, wherein
the display controller is configured to generate the two or more sub-images that are some of the multiple sub-images.

11. The projection display apparatus according to claim 10, wherein
the liquid crystal light valve is configured to alternately repeat the first driving and the second driving, in units of the driving cycle.

12. The projection display apparatus according to claim 10, wherein
the liquid crystal light valve is configured to
repeat the first driving and the second driving in this order, in units of the driving cycle, in a first period of displaying a predetermined number of sub-images that are same in number as the multiple sub-images, and
repeat the second driving and the first driving in this order, in units of the driving cycle, in a second period of displaying the predetermined number of sub-images, subsequent to the first period.

13. The projection display apparatus according to claim 10, wherein
the liquid crystal light valve is configured to alternately repeat the first driving and the second driving, in units of a frame period of performing display on a basis of the two or more sub-images corresponding to the frame image.

14. The projection display apparatus according to claim 1, wherein
the multiple sub-images include multiple pixel values arranged in multiple arrangement patterns different from each other,
the multiple arrangement patterns include a first arrangement pattern, a second arrangement pattern, a third arrangement pattern, and a fourth arrangement pattern, and
the display controller is configured to generate, on the basis of the frame image, the two or more sub-images that are some or all of a first sub-image including multiple pixel values arranged in the first arrangement pattern, a second sub-image including multiple pixel values arranged in the second arrangement pattern, a third sub-image including multiple pixel values arranged in the third arrangement pattern, and a fourth sub-image including multiple pixel values arranged in the fourth arrangement pattern.
